(19) United States
(12) Patent Application Publication
(10) Pub. No.: US 2026/0200765 A1
(43) Pub. Date: Jul. 16, 2026

(54) METHODS AND SYSTEMS FOR PFAS DESTRUCTION USING PHOTOCHEMICAL/ELECTROCHEMICAL REDUCTION OF REAGENTS

(71) Applicant: Claros Technologies Inc., Minneapolis, MN (US)

(72) Inventors: Zekun Liu, Brooklyn Park, MN (US); Terrance P. Smith, Woodbury, MN (US); Andrew Thomas Healy, Minneapolis, MN (US); Adam Michael Hilbrands, Minneapolis, MN (US); Evan Anthony Leslie, Minneapolis, MN (US); James McKone, Roseville, MN (US)

(73) Assignee: Claros Technologies Inc., Minneapolis, MN (US)

(21) Appl. No.: 19/447,250

(22) Filed: Jan. 13, 2026

Related U.S. Application Data
(60) Provisional application No. 63/744,453, filed on Jan. 13, 2025.

(51) Int. Cl. C02F 1/32; C02F 101/36

(52) U.S. Cl. CPC C02F 1/325; C02F 2101/36; C02F 2201/32

(57) ABSTRACT

Methods and systems for destroying PFAS including advanced reductive processes including exposing a PFAS solution to ultraviolet light from a ultraviolet light source having one or more bulbs with a maximum light intensity at 200 nm to 250 nm, in which the PFAS solution includes one or more PFAS having an initial concentration of carbon fluorine bonds and a photosensitizer including a sulfite salt, the sulfite salt having a concentration of a minimum of 0.1 mM to a maximum of 10 times the level of carbon fluorine bonds of the PFAS, with the PFAS solution having a pH of 9 or higher.

### RELATED APPLICATIONS

This application claims priority to U.S. Provisional Application No. 63/744,453, entitled Methods and Systems for PFAS Destruction Using Photoelectric Reduction of Reagents, filed Jan. 13, 2025, the full disclosure of which is hereby incorporated by reference.

### BACKGROUND

Per- and polyfluoroalkyl substances (PFASs) are a class of synthetically prepared compounds that have been used for decades in numerous consumer and industrial applications. PFASs have some unique surface properties and can also be both hydrophobic and oleophobic. As a result, PFASs are used as coating aids, lubricants, foaming aids and various surface treatments. They have proven especially useful as flame retardants in the form of aqueous film-forming foams (AFFF). Also, some PFASs are known to bio-accumulate in plants and animals. There is a growing body of evidence that exposure to PFASs can also cause a variety of health problems. Owing to these concerns, various world-wide regulatory agencies have started to establish strict limits to the presence of PFAS in food and water.

PFASs are a class of chemicals that contain perfluoroalkyl or polyfluoroalkyl groups. The definition and classification of PFASs has changed over time. PFASs are fluorinated substances that contain at least one fully fluorinated methyl or methylene carbon atom (without any H/Cl/Br/I atom attached to it), i.e. with a few noted exceptions, any chemical with at least a perfluorinated methyl group (—CF₃) or a perfluorinated methylene group (—CF₂—) is a PFAS. Some of the most important examples of PFASs include the perfluorosulfonic acids (PFSAs), such as perfluorooctanesulfonic acid (PFOS) and the perfluorocarboxylic acids (PFCAs) like perfluorooctanecarboxylic acid (PFOA). Fluorotelomers are fluorocarbon-based oligomers, or telomers, synthesized by telomerization. Some fluorotelomers and fluorotelomer-based compounds are a source of environmentally persistent perfluorinated carboxylic acids such as PFOA.

The persistence of PFASs, the health issues, and the regulatory landscape have prompted a great deal of research effort to reduce their presence in the environment. Much of the early work was focused on capture, for example from drinking water. However, more recently, there has been a stronger effort on the destruction of these materials. One of the attributes of PFASs is their resistance towards breaking down in the environment. PFASs are not easily metabolized by organisms, and do not decompose by exposure to visible light or longer wavelength UV irradiation typically found under terrestrial conditions.

Some of the methods that have proven effective for breaking down PFASs are supercritical water oxidation (SCWO) and treatment of PFASs in an aprotic polar solvent. SCWO works by heating water to 374° Celsius under high pressure (over 3000 psi). Therefore, SCWO is quite energy intensive and can suffer from clogging issues. The use of SCWO often requires wastes containing high solids because it relies on the heat capacity (btu) generated from this waste to make the process cost effective. An advantage of SCWO is its short residence time to be effective, on the order of 30 seconds to minutes. The use of basic aprotic media to destroy PFASs suffers from the fact that most waste streams are water-based and therefore not readily transferred to aprotic media that requires minimum water levels. In other cases, generating subcritical water conditions in alkaline environments has also been shown to destroy PFAS compounds. This process, referred to as hydrothermal alkaline treatment (HALT), operates at temperatures around 350° Celsius and pressures around 2400 psi.

Other processes for destroying PFASs involve the use of electrochemistry. Electrochemical destruction can destroy long chain PFASs (for example, PFOS and PFOA), however, shorter chain PFASs are less prone to destruction. It is speculated that the longer chained PFASs readily assemble on the electrodes and therefore can be readily oxidized or reduced. Other work has shown that sonication can result in PFAS destruction.

Improved processes are needed to efficiently and effectively destroy PFAS, particularly PFAS in water.

### SUMMARY

Various embodiments include methods and systems for destroying PFAS. In various embodiments, the method includes destroying PFAS using an advanced reductive process including exposing a PFAS solution to ultraviolet light from an ultraviolet light source, the ultraviolet light source comprising one or more bulbs having a maximum light intensity at 200 nm to 250 nm, wherein the PFAS solution includes one or more PFAS, the PFAS having an initial concentration of carbon fluorine bonds, and a photosensitizer including a sulfite salt having a concentration of a minimum of 0.1 mM to a maximum of 10 times the concentration of carbon fluorine bonds of the PFAS, with a a pH of 9 or higher. The method may further include removing oxygen from the PFAS solution using the sulfite salt, wherein the sulfite salt has a minimum initial concentration of 0.3 mM in the PFAS solution before removing oxygen. In other embodiments, the sulfite salt may not be used to remove oxygen from the incoming solution.

In some such embodiments, the photosensitizer may also include a halide salt. The halide salt may be a bromide salt or an iodide salt, for example. In some such embodiments, the halide salt is a bromide salt which may have a concentration of 1 mM to 40 mM in the PFAS solution. In some embodiments, the ratio of the bromide salt concentration to the sulfite salt concentration in the PFAS solution may be. 1 to 100, or the ratio of the bromide salt concentration to the sulfite salt concentration in the PFAS solution may be 1 to 80, for example. In some embodiments, the halide salt is an iodide salt which may have a concentration of 1 micromolar to 100 micromolar in the PFAS solution. In some embodiments, the ratio of the iodide salt concentration to the sulfite salt concentration in the PFAS solution may be 0.001 to 1, or the ratio of the iodide salt concentration to the sulfite salt concentration in the PFAS solution is 0.0016 to 0.2, for example.

In some embodiments, the sulfite salt may be the only photosensitizer in the PFAS solution. In some embodiments, the PFAS solution may not include a halide salt.

In some embodiments, the ultraviolet light source maximum light intensity may be at 200 nm to 230 nm. The ultraviolet light source may be an excimer lamp, such as a krypton/chloride lamp. In some embodiments, the excimer lamp may have a maximum light intensity at about 222 nm.

Various other embodiments includes a method of destroying PFAS including continuously flowing an aqueous solution through one or more photochemical reactors, the aqueous solution including one or more PFA having an initial concentration of carbon fluorine bonds, and a photosensitizer including a sulfite salt at a concentration between a minimum of 0.1 mM and a maximum of no greater than 10 times the concentration of carbon fluorine bonds, and having a pH of 9 or higher. The method further includes exposing the continuously flowing aqueous solution to UV light from one or more UV light sources in the one or more photochemical reactors, with the UV light sources producing UV light with a maximum light intensity at 200 nm to 250 nm. In some such embodiments, the photosensitizer may further include a halide salt, such as a bromide salt or an iodide salt. In some embodiments, the halide salt is a bromide salt at a concentration of 1 mM to 40 mM in the aqueous solution. In some embodiments, the ratio of the bromide salt concentration to the sulfite salt concentration in the PFAS solution is 0.1 to 100, or the ratio of the bromide salt concentration to the sulfite salt concentration in the PFAS solution is 1 to 80, for example. IN some embodiments, the halide salt is an iodide salt at a concentration between 1 micromolar to 100 micromolar in the aqueous solution. In some embodiments, the ratio of the iodide salt concentration to the sulfite salt concentration is 0.001 to 1, or the ratio of the iodide salt concentration to the sulfite salt concentration is 0.0016 to 0.2, for example. In some embodiments, the sulfite salt is the only photosensitizer in the PFAS solution. In some embodiments, the PFAS solution does not include a halide salt. In various embodiments, the one or more photochemical reactors includes two or more photochemical reactors in series, with the aqueous solution flowing continuously through the two or more photochemical reactors.

Various other embodiments include a continuous flow UV photoreactor including a reactor vessel including a tube with a proximal end, an opposing distal end, a proximal portion and a distal portion, with the proximal portion relatively closer to the proximal end, and the distal portion is relatively closer to the distal end. The photoreactor further includes a fluid inlet at the proximal end, a fluid outlet at the distal end, a photochemical chamber within the tube between the proximal and distal ends, one or more elongated UV lamps in the photochemical chamber, one or more cathodes within the photochemical chamber, and one or more anodes distal to the one or more cathodes, wherein the one or more anodes are electrically connected to the one or more cathodes. The photoreactor may further include a power supply connected to the anode and cathode. In some embodiments, the one or more anodes may be located in the distal portion of the tube. In some embodiments, the one or more anodes are located distal to the distal end of the tube.

In some such embodiments, the photoreactor may further include a plurality of baffles within the photochemical chamber. In some embodiments, one or more of the plurality of baffles may include the one or more cathodes, and one or more of the plurality of baffles may include the one or more anodes. In some embodiments, one or more of the plurality of baffles may include the one or more cathodes, and the one or more anodes may include an electrically conductive mesh. In some embodiments, the one or more cathodes and the one or more anodes may include electrically conductive meshes.

In some embodiments, the proximal portion of the reactor may include approximately a proximal 50 percent of the tube, and the distal portion may include approximately a distal 50 percent of the tube. In other embodiments, the proximal portion of the reactor may include approximately a proximal 70 percent of the reactor, and the distal portion may include approximately a distal 30 percent of the reactor. In various embodiments, the one or more elongated UV lamps may extend through the proximal and the distal portions of the photochemical chamber reactor. In various other embodiments, the one or more elongated lamps may extend through the proximal portion of the photochemical chamber only and may not extend into the distal portion of the photochemical chamber.

### BRIEF DESCRIPTION OF THE DRAWINGS

The following drawings are illustrative of embodiments and do not limit the scope of the invention. The drawings are not necessarily to scale and are intended for use in conjunction with the following detailed description. Embodiments of the invention will be described with reference to the drawings, in which like numerals may represent like elements.

FIG. 1 is a schematic showing a PFAS destruction reactor system diagram according to various embodiments;

FIG. 2 is a schematic showing a PFAS destruction reactor system diagram according to other embodiments;

FIG. 3 is an example of a photoreactor without modification of the inlet and outlet ports;

FIG. 4 is a cross sectional view of an array of light sources as used in a UV photoreactor according to various embodiments;

FIG. 5 is an image of a UV light support system according to various embodiments;

FIG. 6 is an image of the UV light support system of FIG. 5 with the lamp sleeves removed;

FIG. 7 is an image of the perforated disks of the UV light support system of FIG. 5;

FIG. 8 is an image of one configuration of a perforated disk of the UV light support system of FIG. 5;

FIG. 9 is an image of an alternative configuration of a perforated disk of the UV light support system of FIG. 5;

FIG. 10 is an example of a process including photochemistry and an electrolytic process for PFAS destruction;

FIG. 11 is an example of a system for continuous photochemical PFAS destruction with an electrolytic process;

FIG. 12 is another example of a system for continuous photochemical PFAS destruction with an electrolytic process;

FIG. 13 is a graph showing a summary of literature concerning sulfite and iodide use, separately or together, for the treatment of perfluorocarboxylic and perfluorosulfonic materials under UV 254 nm irradiation;

FIG. 14 a graph of PFBA destruction percentage at varied reagent dosing versus time;

FIG. 15 is a graph of PFBA concentration in influent in ppb and effluent in ppt versus time under two reaction conditions according to one example;

FIG. 16 is a graph of PFBA concentration in influent in ppb and effluent in ppt versus time under various reaction conditions according to another example;

FIG. 17 is a graph of PFBA concentration in influent in ppb and effluent in ppt versus time under various reaction conditions according to still another example;

FIG. 18 is a diagram of an 18 GPM sequential destruction process;

FIG. 19 is a graph of PFBA concentration in influent in ppb and effluent in ppt versus time under various reaction conditions including a first pass and a second pass through a continuous reactor;

FIG. 20 is a graph of a model of destruction of PFAS at a concentration 0.1× concentration over a range of sulfite and iodide concentrations;

FIG. 21 is a graph of a model of PFAS destruction of FIG. 20 over a broader range of sulfite and iodide concentrations;

FIG. 22 is a graph of a model of PFAS destruction of FIGS. 20 and 21 over an even broader range of sulfite and iodide concentrations;

FIG. 23 is a graph of a model destruction of PFAS at a concentration of 1× concentration over a range of sulfite and iodide concentrations;

FIG. 24 is a graph of a model of PFAS destruction of FIG. 23 over a broader range of sulfite and iodide concentrations;

FIG. 25 is a graph of a model of PFAS destruction of FIGS. 23 and 24 over an even broader range of sulfite and iodide concentrations;

FIG. 26 is a graph of a model destruction of PFAS at a concentration of 5× concentration over a range of sulfite and iodide concentrations;

FIG. 27 is a graph of a model of PFAS destruction of FIG. 26 over a broader range of sulfite and iodide concentrations;

FIG. 28 is a graph of a model of PFAS destruction of FIGS. 26 and 27 over an even broader range of sulfite and iodide concentrations;

FIG. 29 is a graph of a model destruction of PFAS at a concentration of 100× concentration over a range of sulfite and iodide concentrations;

FIG. 30 is a graph of the model of PFAS destruction of FIG. 29 over a broader range of sulfite and iodide concentrations;

FIG. 31 is a graph of the model of PFAS destruction of FIGS. 29 and 30 over an even broader range of sulfite and iodide concentrations;

FIG. 32 is a graph of destruction efficiency as a function of sulfite range for a PFAS level of about 250 ppb;

FIG. 33 is a graph of destruction efficiency as a function of sulfite range for a PFAS level of about 2.5 ppm;

FIG. 34 is a graph of destruction efficiency as a function of sulfite range for a PFAS level of about 12.25 ppm;

FIG. 35 is a graph of destruction efficiency as a function of sulfite range for a PFAS level of about 250 ppm;

FIG. 36 is a graph of experimental results of destruction and defluorination of PFOA at 222 nm under various bromide concentrations and 1 mM sulfite;

FIG. 37 is a graph of experimental results of destruction and defluorination of PFOA at 222 nm under various bromide concentrations and 4 mM sulfite;

FIG. 38 is a graph of experimental results of destruction and defluorination of PFOA at 222 nm under various bromide concentrations and 10 mM sulfite;

FIG. 39 is a graph of experimental results of defluorination of PFOA at 222 nm under various sulfite concentrations and 20-40 mM bromide;

FIG. 40 is a contour plot of experimental results defluorination of PFOA by a UV222 nm/Sulfite-Bromide photoreduction system;

FIG. 41 is a contour plot of kinematic model results for destruction of PFOA in gallons per minute as a function of sulfite concentration and bromide concentration;

FIG. 42 is a schematic diagram of a tri-reactor system.

FIG. 43 is a graph showing the % defluorination versus sulfite sensitizer concentration in a tri-flow reactor at a pH=11 with 222 nm UV light and no additional halide added;

FIG. 44 is a schematic diagram of an electrochemical reactor that uses a 254 mn UV light source; and

FIG. 45 is a plot of the absorption spectra of the effluent of a PFAS containing solution that has been treated with 254 nm UV light and undergone electrochemistry without enhanced electrolyte.

### DETAILED DESCRIPTION

The systems and methods described herein relate to processes for the photochemical destruction of PFASs using UV photolysis. The UV photolysis is based on generating a highly reducing species, such as solvated electrons, produced by the irradiation of a photosensitizer. The photosensitizer or sensitizer absorbs UV energy and generates a solvated electron and an oxidized sensitizer species. The solvated electrons can react with a PFAS molecule. In some embodiments, UV photolysis may include oxidative processes.

Various embodiments include processes to increase the efficiency of the photochemical destruction of PFAS and allow photochemical methods to be more generally used on a variety of PFAS-containing waste streams, including efficiently reducing PFAS to very low levels. Other embodiments include UV photolysis reactor designs such as continuous reactor designs to accomplish more efficient destruction of PFASs.

Various embodiments include photochemical destruction of PFASs as a method to destroy the so-called “Forever Chemicals”. In some embodiments, the photochemical system includes a reactor vessel with one or more UV light sources. The reactor may be charged with a solution consisting of one or more PFAS, water (or another solvent), and sensitizers capable of absorbing UV light and producing a reactive species. In addition, there optionally may be one or more other chemical additives to promote the reaction. The process, systems and methods disclosed herein may result in improved efficiencies, lower costs, and use of less chemicals.

In some embodiments, the UV photolysis systems and methods may be used to treat PFAS present in wastewater or other water sources directly, such as in a high throughput treatment system. In other embodiments, the UV photolysis systems and methods may be used to treat PFAS which has been extracted or absorbed and isolated and/or concentrated from the environment, such as from wastewater or other water sources. This PFAS may be suspended or dissolved into an aqueous solution for use in the UV photolysis methods and systems described herein.

The methods and systems of PFAS destruction described herein include the ability to destroy PFAS contaminants, including carboxylated and sulfonated PFAS contaminants. Examples of PFAS which may be destroyed by the embodiments described herein include but are not limited to Trifluoroacetic Acid (TFA), Perfluorobutanoic acid (PFBA), perfluoropentanoic acid (PFPeA), Perfluorohexanoic acid (PFHxA), Perfluorooctanoic acid (PFOA), Perfluorobutanesulfonic acid (PFBS), Perfluorohexanesulfonic acid (PFHxS) and Perfluorooctanesulfonic acid (PFOS). More than one type of PFAS may be treated and destroyed simultaneously using the photoreaction methods described herein.

Destruction of the PFAS includes a change in the identity of the target chemical pollutant through the cleavage of chemical bonds. Destruction that yields complex chemical compounds as final products is referred to as degradation. Destruction includes removing one or more chemical groups which may reduce or eliminate toxicity.

The PFAS used in various embodiments may be in aqueous solution, such as PFAS present in a water from a contaminated natural source or other source or may be concentrated by a prior capture or pretreatment method or other treatment method. PFASs are found in many waste streams, and any of these waste streams may be treated using the methods and systems described herein. Some common PFAS-containing waste streams that may be treated according to various embodiments include effluent from industrial producers of PFASs, effluent from textiles plants, foam fractionation concentrates, Aqueous Film-Forming Foams (AFFF), AFFF rinsates, landfill leachates, contaminated ground water, municipal water waste streams, and pot still bottoms.

UV reactors used in various embodiments may include one or more continuous reactors and/or one or more batch reactors. In some embodiments, the system for the UV destruction of PFAS may include a single reactor vessel in which pretreatment, photolysis, and the post-treatment steps are sequentially performed. In other embodiments, one or more or all of the steps of pretreatment, photolysis, and post treatment may occur in separate vessels or chambers of a vessel, such as for continuous processes. In some embodiments, the UV photolysis process may be performed using one or more reactor vessels, including batch reactors and/or continuous reactor vessels, with one or more UV light sources. The reactor may be charged with wastewater that may optionally be pretreated and includes PFAS, water and sensitizers capable of absorbing UV light and producing a reactive species. In addition, there optionally may be one or more other chemical additives to promote the reaction.

The reactor vessel may include one or more UV light sources emitting light, such as UV lights with a maximum light intensity at 222 nm or 254 nm. In some embodiments, multiple wavelengths may be emitted from a light source, or from various light sources, and other wavelengths of lights in addition to 222 nm and 254 nm may contribute to PFAS photoreduction, such as 185 nm. In some embodiments the UV light sources may emit a maximum light intensity emitted between 200 nm to 250 nm.

The photoreactor may be used alone, or in combination with other reactors, such as in series, which may employ a photoreduction at the same or different wavelength or may employ other PFAS destruction methodologies. Alternatively, one or more steps may be performed in the same vessel.

Examples of PFAS capture systems, treatment systems, pretreatment systems and posttreatment systems are provided in the applicant's other applications, such as U.S. patent application Ser. No. 18/212,603, entitled METHOD AND APPARATUS FOR THE DESTRUCTION AND DEFLUORINATION OF PER-AND POLYFLUOROALKYL SUBSTANCES (PFAS), FLUOROTELOMERS AND OTHER PERSISTENT ORGANIC POLLUTANTS filed Jun. 21, 2023, U.S. Pat. App. No. 63/513,782 entitled PROCESSES FOR EFFICIENT PHOTOCHEMICAL DESTRUCTION OF PFAS FROM WASTE STREAMS filed Jul. 14, 2023, and U.S. patent application Ser. No. 18/555,135 entitled SORBENTS AND METHODS FOR THE CAPTURE AND DEFLUORINATION OF PER AND POLY FLUOROALKYL SUBSTANCES (PFAS) and filed Oct. 12, 2023 (national stage entry), the disclosures of all of which are hereby incorporated by reference. The systems and methods described herein may be used in combination with the methods and systems described in these applications.

One example of a photoreactor which may be used in various embodiments comprises one or more lamps, such as lamps including cylindrical bulbs or other bulb shapes, and one or more photoreactor vessels configured such that the light of the lamp will project onto the contents of the reactor vessel or vessels. The lamps may be supported on a frame such as a metal support frame, at a desired distance over a top surface of a photoreactor vessel and/or above the top surface of liquid in the photoreactor vessel when in use to shine directly on the surface of the reaction solution or to shine through the reactor vessel wall. Alternatively, the lamp may fit into the reactor vessel to shine light directly onto the contents from within the reactor vessel. The bulb may be protected and/or separated from the reaction solution within the reactor vessel, such as by a sleeve or other barrier. In some embodiments, the photoreactor vessel may include two or more cylindrical lamps, such as between 5 and 150 lamps or between 10 and 100 lamps, and a support frame holding the lamps horizontally at a selected distance above a level surface of a photoreactor vessel or within sleeves within the treatment solution. Other light and reactor vessel configurations and orientations may be used to optimize energy delivery and PFAS destruction. Furthermore, in various embodiments, the photoreactor could be a tube reactor like the continuous photoreactors described herein, but it may not be horizontally oriented. Rather, the tube could be vertically oriented or could be oriented at an angle between horizontal and vertical.

The photoreactor vessel may be any appropriate material such as quartz or other material which is non-reactive and is transparent to the wavelength of light used for the PFAS destruction. In other embodiments, such as those in which the bulb is located within the reactor vessel, the reactor vessel need not be transparent and may be a nontransparent and nonreactive material such as stainless steel. The vessel may be configured to contain a fluid and may include a top which may seal the vessel and/or inlet and outlet ports. The reactor vessel may be any size or shape. In some embodiments, the reactor vessel is cylindrical. The lamp(s), lamp support, and the reactor vessel may be contained in a housing such as a metal enclosure or other enclosure.

Examples of lamps which may be used in various embodiments include krypton-chloride excimer lamps emitting radiation at 222 nm. Other excimer lamps which emit a narrow band of radiation at other wavelengths could alternatively be used. The lamps may consume 100 Watts of power or could consume more or less power, such as 150 Watts, 300 Watts, 600 Watts, 800 Watts or 1000 Watts. The power supply to the lamps may be 20 kilovolts or may be more or less than 20 kilovolts. In some embodiments, the lamp powers for lamps including those emitting at 222 nm and 254 nm, for example, may be between about 50 and about 5000 W, such as between about 100 and about 1000 W or between about 100 and about 600 W. Single lamps may be used or multiple lamps, which may be identical or different.

The photoreaction methods described herein may be performed at room temperature or at a temperature greater than room temperature. For example, in some embodiments, the temperature of the photoreactor may be between about 55° Celsius and about 60° Celsius during the reaction. However, higher or lower temperatures could alternatively be used. In addition, heating and/or cooling elements could be added to the reactor and/or to the room containing the reactor to raise or lower the temperature, such as air-ducting, fans and lamps.

The reactor solution may be stationary during UV treatment, or it may be agitated, or it may flow past the lamps such as in a continuous flow reactor such as a cylindrical reactor. For example, the reactor may include stirrers or agitators with the capacity to stir or agitate the solutions. Alternatively, the solution may enter the reactor flowing continuously through an inlet at one end, flow continuously through the reactor between and around the UV lights, and exit the reactor through an outlet at the opposite end, still flowing continuously. In some embodiments, stirring or agitating the reactor solution, or the flow of the solution through the reactor, during irradiation may facilitate exposure of PFAS compounds to regions of higher radiation. In some embodiments, the solution may be recirculated through a heat exchange unit. The UV reactor may further include a sensor module configured to allow continuous monitoring of the physical and/or chemical state of the reaction solution. The sensor system in some embodiments one or more sensors configure to monitor one or more of the following: temperature, pressure, pH, UV intensity, fluoride ion concentration, and oxidation-reduction potential. In some embodiments, the UV reactor may also include one or more ports for adding additional reagents and/or sampling the reaction mixture. The additives charged from the ports can be added to the treatment solution continuously and/or in one or more batches, within the reactor and/or upstream of the reactor. Typical additives include, but are not limited to sensitizers, sulfite salts, initiators, bases such as sodium hydroxide or sodium carbonate.

Sulfite ion, SO₃⁻², is an important component in the PFAS destruction process. The sulfite ion can remove dissolved oxygen from the solution and sulfite can act as a sacrificial reductant to reduce the oxidized photosensitizer and regenerate the photosensitizer. The sulfite ion can be produced by dissolving an alkali metal salt of sulfite such as sodium sulfite (Na₂SO₃) or potassium sulfite (K₂SO₃) in aqueous media with pH above 7. Alternatively, the sulfite ion can be provided by using a bisulfite salt such as sodium sulfite (NaHSO₃) or potassium sulfite (KHSO₃). Bisulfite salts react with water or base to generate the sulfite ion. For example:

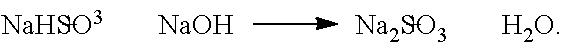

Also, metasulfite (S₂O₃²⁻) salts, such as Na₂S₂O₅, may be used. The metasulfite ion undergoes the following reaction with water,

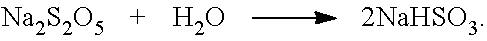

Under basic conditions the bisulfite will deprotonate to form sulfite. The term sulfite or sulfite salt used in this invention can refer to sulfite provided by any of these materials. When sulfite, bromide, or iodide is mentioned it is understood that there are corresponding cations in the solution to balance the charge.

Some embodiments result in complete destruction of the PFAS or near complete destruction, such as greater than 99% destruction. Some embodiments result in at least 90% or at least 95% destruction of PFAS, such as about 90% to about 100%, or about 95% to about 100% destruction of PFAS. For example, in some embodiments, PFAS levels may be reduced to less than 100 ppt or less than 50 ppt, such as between about zero or about 1 ppt and about 100 ppt, or between about zero or about 1 ppt and about 50 ppt.

Various embodiments include a sensitizer which may be added to the wastewater. The photolysis method includes generating a highly reducing species, such as a solvated electron, produced by the irradiation of a photosensitizer. Photosensitizers which may be used in various embodiments include halides, pseudo halogens, inorganic oxoanions, anionic metal complexes, metal clusters, Zintl Compounds, nanometal particles of transition metals, organic anions, nitrogen heterocycles, boron-doped nanodiamonds, and/or nitrolotriacetic acid. These sensitizers may be used in combination or separately (individually) in conjunction with different light sources.

Examples of halides which may be used in various embodiments include iodide, chloride, and bromide. Examples of pseudohalogens which may be used include cyanide, isocyanate, cyanate, isocyanide, isocyanate, azide, hydroxide, hydrosulfide, hydroselenide, hydrotelluride, fulminate, thiocyanate, selenocyanate, tellurocynate, isothiocyanate, nitroxide, tetracarbonyl colbaltate, trinitromethanide, tricyanomethanide, 1,2,3,4-thiatriazol-5-thiolate, fulminate, cyaphide, and auride. Examples of inorganic oxoanions which may be used include sulfite (SO₃²⁻), sulfate (SO₄²⁻), hyposulfite (SO₂²⁻)thiosulfate (S₂O₃²⁻), carbonate (CO₃²⁻), phosphate (PO₄³⁻), phosphite (PO₃³⁻), hypophosphite (PO₂³⁻), and borate (BO₃³⁻), including protonated forms of these anions (e.g. HSO₃⁻, HSO₄⁻, HCO₃). Examples of anionic metal complexes which may be used include ferricyanide ion, ferrioxalate ion, tetrachloroplatinate ion, hexachloroiridate ion, cyanocuprates and cerium (III) complexes). Examples of metal clusters that may be used include Mo₆Cl₁₄²⁻, Zr₆CCl₁₂⁴⁻, Ta₆Cl₁₈⁴⁻, Re₃Cl₁₂³⁻, and iron sulfur clusters. Examples of Zintl Compounds that may be used include [Bi₃]³⁻, [Sn₉]⁴⁻. Examples of nanometal particles of a transition metals that may be used include gold, copper and iron. Examples of organic anions that may be used include ascorbic acid anion, ascorbic acid dianion, phenolates, creosootes, dihydroxybenzenes anions, methoxyphenolates, thiophenolates. Examples of nitrogen heterocycles that may be used include indole-3-acetic acid.

Other components which may be included in the treatment solution in the reactor include photosensitizers such as halide salts alone or in combination with other components such as sulfites. The concentration of the sensitizer may depend on the electronic absorption spectra of the sensitizer, the spectral output of the lamp, the concentration of other sensitizers contained within the reactor, and the concentration of PFAS within the solution.

In some examples, components which may be included in the treatment solution in the reactor include halide salts alone or in combination with other components such as sulfites. In some embodiments, such as embodiments utilizing light sources emitting a maximum intensity of light at UV222 nm or UV254 nm, KI and Na₂SO₃, may be included in the reactor solution. In some embodiments, it may be preferable to maintain a high pH during photoreduction, such as a pH of 9 or more, or 11 or more, or 12 or more. In embodiments using UV222 nm light a pH of 9 to 12.5 may be preferred. Therefore, in addition to the reagents discussed above, it may be useful to include a base such as sodium carbonate and/or one or more other bases such as sodium hydroxide in the reactor solution to increase the efficiency of the reaction.

Low pressure mercury lamps, medium pressure mercury lamps and mercury amalgam lamps may be used as the source of UV radiation in various embodiments, because of their relatively low cost and high efficiency of converting electrical energy into UV photons, for example. Mercury vapor lamps exhibit pronounced spectral lines in the ultraviolet and visible. For PFAS destruction, 184.5 nm (typically referred to as 185 nm) and 253.7 nm (typically referred to as 254 nm) are important wavelengths. However, other light sources can also be used in various embodiments. In particular, various excimer lamps which have high efficiency, high-powered, narrow-band radiation across the UV spectrum (near UV to Vacuum UV) are also excellent light sources and may be used in various embodiments. Excimer lamps are a type of discharge lamp that involves rare gases such as argon (Ar), krypton (Kr) or Xenon (Xe), or halogen dimers (F₂, Cl₂ Br₂ or I₂) or combinations of halogens and rare gases. The UV light from an excimer source is due to emission from the excited state of rare gas dimer (Ar₂*, Kr₂*and Xe₂*), halogen dimers (F₂*, Cl₂*Br₂*or I₂*) and rare-gas halide excimers (ArF*, ArCl*, ArBr*, ArI*, KrF*, KrCl*, KrBr*, KrI*, XeF*, XeCl*, XeBr*and XeI*), where the asterisk denotes an excited state. Examples of excimers light sources and their principle emission output that may be used in various embodiments include XeXe* (172 nm), ArCl* (175 nm), KrI* (190 nm), ArF* (193 nm), KrBr* (207 nm), KrCl* (222 nm), KrF* (248 nm), XeI (253 nm), Cl₂*(259 nm), XeBr*, Br₂*(289 nm) and XeCl* (308 nn). In some embodiments, preferred lamps may have outputs between 172 nm and 289 nm, for example. The wavelength output and availability of powerful KrCl* excimer lamps make them especially preferred in certain embodiments. Although the efficiencies of excimer lamps may not be as high as the efficiencies from mercury lamps, the ability to fine tune the light emission to a given sensitizer is useful to the overall effectiveness of photochemical process in various embodiments. These lamps have the added advantage of not containing mercury. Other UV light sources that may be used in various embodiments include xenon arc lamps, deuterium arc lamps mercury/xenon arc lamps, metal/halide arc lamps, and UV LEDs. The amount of light (power) from a UV LED is generally much lower than mercury or other discharge lamps and therefore multiple LEDs may be included in various embodiments to destroy PFASs in a time frame of minutes to hours, for example. Ultraviolet Light emitting diodes can also be used as light sources.

Various embodiments include continuous reactors which provide a continuous flow of the PFAS solution through the reactor during UV treatment. Such continuous reactors may be hollow cylinders or tubes, with elongated lamp bulbs within transparent sleeves extending lengthwise through the length of the cylinders. An inlet may be located at or near one end, and an outlet may be located at or near the opposing end, with the lamps spaced within the reactor to allow wastewater to flow between them, treating the water within range of the lamps as it passes the lamps. The continuous reactor system may provide equal continuous input and output flows entering and exiting the reactor or reactors, with a new supply of PFAS solution continuously flowing past the UV light sources during treatment, and without the need to pause the treatment process to evacuate and reload the reactor with a new batch of treatment solution.

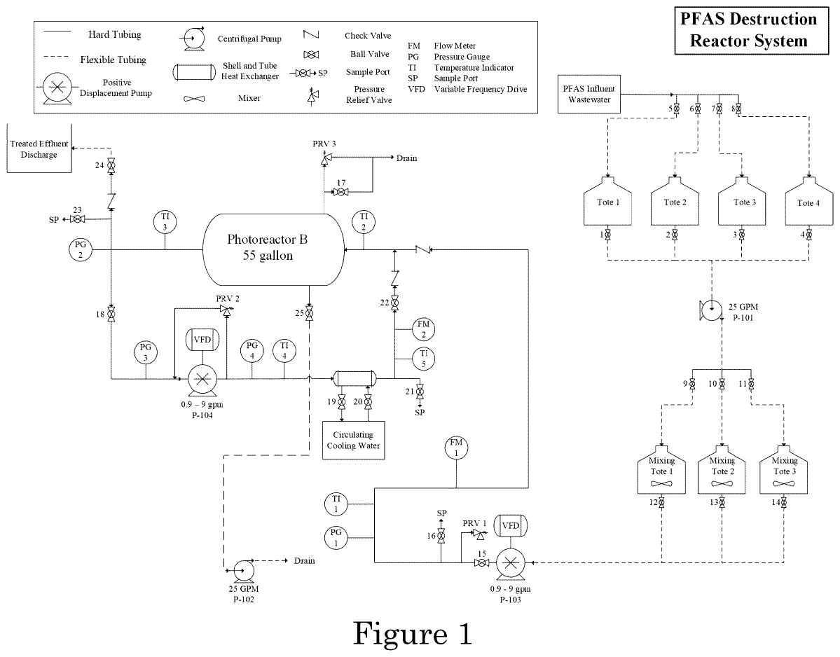

An example of a continuous flow reactor system which may be used in various embodiments is shown in FIG. 1. This figure shows a piping and instrumentation diagram for a PFAS destruction system using UV light and photosensitizers, but other configurations of piping and instrumentation could alternatively be used. In this example, the system includes two subsystems, a feed subsystem and a treatment subsystem. In this example, the reactor can be operated in either batch mode and continuous mode. However, in alternative embodiments, the reactor may be capable of only continuous operation or only batch mode operation.

The feed subsystem includes a plurality of totes connected in parallel to a supply flow of wastewater influent, and a plurality of mixing totes downstream of the totes with the mixing totes also connected in parallel. In this example, there are four totes and three mixing totes, but other numbers of totes and/or mixing totes could alternatively be used in the system. Other systems may not include totes.

Various pumps may be used to transfer the solution, such a transfer centrifugal pump (P-101) and positive displacement (PD) pump (P-103). Transfer centrifugal pump transfers solution between the totes and the mixing totes, and positive displacement pump transfers solution between the mixing totes and the photoreactor. A variable frequency drive (VFD) is configured to control the flow rate. For example, the variable frequency drive may be set manually based on the flow meter's digital output.

The feed subsystem also includes a plurality of valves configured for isolation that allow for simultaneous filling of staging totes, transferring of mixing totes, and draining. The mixing tanks are equipped with mixers and used to introduce chemicals into the raw wastewater materials. The wastewater in each mixing tote may be validated for optimal pH and regular UV transmittance using pH and UV transmission sensor before being transferred to the reactor. Although not shown, the system may also include a plurality of supply tanks for chemicals which are added to the wastewater solution, such as iodide, sulfite and base, in flow connection with the mixing totes through pipes which may be controlled by valves and pumps. The system may also include meters at various locations.

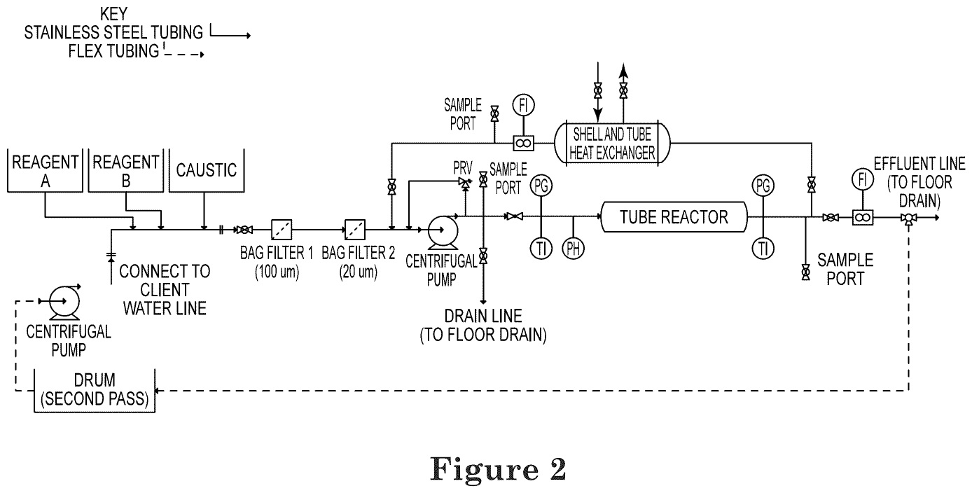

In the example shown in FIGS. 1 and 2 (discussed further below), the reactor is a horizontal cylindrical pressure vessel. An example of a reactor which may be used as a basis for a photoreactor in various embodiments, after modification as described below, is shown in FIG. 2. The dimensions of the vessel may vary. In one example, the reactor vessel has an approximate length of 80 inches, such as between about 50 and about 120 inches, and an approximate diameter of about 18 inches, such as between about 12 and about 25 inches. In this example, the vessel contains about 50 low-pressure high-output UV lamps, such as 48 lamps, each with a nominal 150 W power lamp, with predominant emission of 254 nm wavelength. Other numbers of UV lamps may alternatively be used, such as between about 5 and about 100 lamps, or between about 30 and about 70 lamps. Furthermore, lamps having different nominal power may be used, such as between about 50 and about 1200 W, or between about 100 W and about 1000 W, or between about 150 W and about 800 W. In addition, all lamps may have the same predominant wavelength, such as 254 nm or 222 nm or other wavelengths, or 2 or more differing types of lamps may be used having differing predominant wavelengths. The lamps may be elongated and arranged throughout the vessel, as described further later in this disclosure.

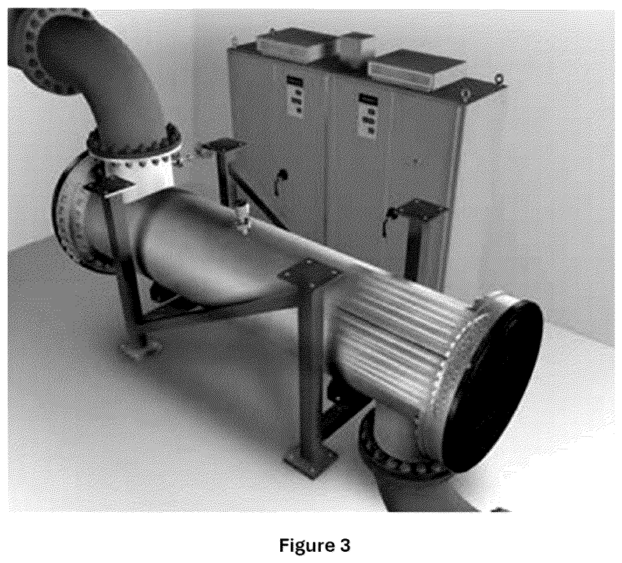

The reactor includes an inlet at one end, and an outlet at the opposite end. Although the inlet and outlet are shown at the ends of the photoreactor in FIGS. 1 and 2, this is for illustrative purposes only. In various embodiments, the inlet and/or outlet may be located within the sidewalls of the photoreactor vessel, at or near the closed ends of the vessel, as shown in FIG. 3. For example, the flow of solution through the inlet may be in a direction approximately perpendicular to the longitudinal axis of the photoreactor, which is the general direction of solution flow through the photoreactor. The inlet may connect with an outer wall of the vessel on the top of the vessel, while the outlet may connect with the outer wall of the vessel on the bottom of the vessel, as shown in FIG. 3, though other configurations are also possible. However, unlike the reactor in FIG. 3, various embodiments may include inlets and outlets which are much smaller than those shown.

In the example shown in FIGS. 1 and 2, the reactor can be operated in either a batch mode or continuous mode, with untreated influent entering the reactor through the inlet and exiting the reactor through the outlet. Throughput rates may be set by an operator and may depend upon factors such as influent parameters including UV transmittance, level, type of background constituents present, and desired effluent properties.

In some embodiments, the system may optionally include a heat exchanger. For example, a heat exchanger may be included in systems which include a batch reactor, or a reactor capable of batch reactions, and may be particularly useful for long batch UV treatments to reduce heating of the UV light source. Systems including heat exchangers may circulate solution as needed to achieve sufficient cooling to maintain a desired temperature. The system may include temperature sensors, such as temperature monitoring indicators (TI2, TI3, TI4), which may be located upstream and/or downstream of the reactor and which may be used to set the heat exchanger's cooling water flow rate.

When the reactor is operating in a batch mode, a pump such as PD pump (P-104) may be configured to push liquid through the UV reactor and heat exchanger, and the solution may circulate through the heat exchanger multiple times. For example, when the reactor is operated in batch mode, the feed subsystem may be configured to fill the photoreactor vessel with the solution containing PFAS and reagents using one or more pumps and valves, such as PD pump (P-103).

The system may also include a pressure relief system configured to isolate overflow, which may be controlled by a valve such as valve 17. The pressure relief system may prevent over pressure in the photoreactor in batch mode and in continuous mode.

The reactor may alternatively operate in a continuous mode. For example, the treatment subsystem may be configured such that the flow path of the solution does not pass through the optional heat exchange recirculation path (or the heat exchange recirculation path is omitted). Rather, the flow path of the solution may pass directly through the reactor to the effluent discharge or to post treatment systems or processes.

When the photoreactor is operating in continuous mode, or when the photoreactor is only configured for continuous treatment, the treatment subsystem may be configured to utilize the feed subsystem to provide a constant solution supply as a rate which may be controlled by a user. For example, a pump, such as PD pump (P-103), may be configured to suction-lift liquid from a mixing tote across a range of flow rates through the reactor. In this example, the variable frequency drive (VFD) of the PD pump (P-103) may be used to control the solution flow rate. VFD is adjusted based on the flowmeter reading downstream of the pump. Once the pump is set, the VFD is left untouched unless a change in flow rates is desired.

The example system shown in FIG. 1 includes various components, including 4 staging totes, 3 mixing totes each with mixers, 2 centrifugal Pumps (P-101, P-102), 2 positive displacement pumps (P-103, P-104), a heat exchanger (HX), 5 digital temperature indicators (TI1, TI2, TI3, TI4, TI5), 4 analog pressure gauges (PG1, PG2, PG3, PG4), 2 digital flowmeter s (FM1, FM2), 2 variable frequency drives (VFD), 3 pressure relief valves (PRV-1, PRV-2, PRV-3), 25 ball valves (1, 2, 3, 4, 5, 6, 7, 8, 9, 10, 11, 12, 13, 14, 15, 16, 17, 18, 19, 20, 21, 22, 23, 24, 25), and 2 check valves. Other numbers and configurations of components could also be used, as well as additional or alternative components.

An alternative continuous UV photoreactor system is shown in FIG. 2, which does not include a feed subsystem. In this example, the wastewater flows continuously through influent tubing from a source such as a water line or other line. Reagents may be provided to the wastewater within the influent tubing, such as from a plurality of reagent tanks such as tanks for Reagent A, Reagent B, and Reagent C. The reagent tanks may include one or more photosensitizer system reagents such as iodide and sulfite and a pH adjuster such as a base, for example. The system may include valves or injectors between the reagent tanks and the influent tubing to add the desired amount of each reagent into the influent tubing containing the wastewater to achieve the desired concentration of each reagent in the treatment solution. The reagents may mix with the wastewater as it travels through the influent tubing before entering the photoreactor, with additional mixing occurring as the combined wastewater and reagents pass through a pump such as the Centrifugal Pump shown in this example, with the pump optionally providing all of the mixing necessary and no additional mixing mechanism being required.

Before the wastewater passes into the photoreactor, it may pass through one or more filters in line with the influent tubing. For example, in the system shown in FIG. 2, the wastewater and reagents pass through Bag Filter 1 and Bag Filter 2, with progressively smaller mesh filtration at 100 micrometers and then 20 micrometers. In alternative embodiments, additional or fewer filters may be used, or the filters may be omitted, and different mesh sizes may be used. The choice of filters may depend upon the type of wastewater being treated and whether or not it has previously been filtered, for example. In addition, one or more of the filters could alternatively be located upstream of the reagent supply inlets in the tubing, rather than downstream as shown.

From the centrifugal pump, the wastewater passes into the photoreactor, identified as a tube reactor in this example. As in FIG. 1, the photoreactor in FIG. 2 is a tube reactor which may be operated in either batch mode or continuous mode, but in alternative embodiments the system could include a photoreactor which is exclusively a batch reactor or a continuous reactor. This system also includes an optional heat exchange system, with temperature sensors upstream and downstream of the photoreactor which may be used to control passage of wastewater through the heat exchanger. Some embodiments, such as tube reactors which are continuous reactors, may omit the heat exchanger system and may optionally include or omit one or both temperature sensors. Although not shown, the photoreactor may also include an overflow system as described above with regard to the photoreactor of FIG. 1.

After exiting the photoreactor, the wastewater may exit the system, such as through an effluent tubing line. Alternatively, if the wastewater is to be treated multiple times, it may recirculate back through recirculation tubing to a location upstream of the photoreactor. In the example shown in FIG. 2, the wastewater may circulate back to a storage tank such as the second pass storage drum. From there, it may be pumped back into influent tubing by a pump such as the centrifugal pump to reconnect with the influent tubing at a location such as a location upstream of the reagent inlets.

One example of a photoreactor which may be used in various embodiments is a UV reactor such as the Aquafine Avant 48, shown in FIG. 3, with modifications to allow PFAS destruction, which would not otherwise be successful with the existing reactor. For example, the reactor may be modified such that flow rates through the reactor are sufficiently low, and the flow is sufficiently turbulent, to allow high levels of PFAS destruction. For example, the inlet and outlet may be substantially narrowed. While the Aquafine Avant 48 includes 8 inch flange connections at the inlet and the outlet, when used as a photoreactor for PFAS destruction using the processes described herein, the inlet and outlet may be reduced in size to about 2 inches or less, such as between about 0.5 and about 2 inches, or between about 0.5 and about 1.5 inches, or between about 0.5 and about 1 inch, or about one inch or less, or about 0.75 inches. This may be done, for example, through the use of appropriately sized flanges, such as blind flanges, with the desired size connection, such as the sizes indicated above, such as about 0.75 inch FNPT connection, machined into the center of each. In addition, a pump may be added to the reactor such as a boost pump connected to the inlet with piping such as stainless steel tubing of a size to match the inlet, such as about 0.75 inches. Piping of a size to match the outlet, such as about 0.75 inches, may also be connected to the outlet.

Constricting the inlet and the outlet in this way increase residence time and may avoid “channeling” of the solution through the reactor. UV light within the reactor may only penetrate a certain distance into the solution to be effective at destroying the PFAS, such that locations outside of this distance may be considered dead spaces. By constricting the inlet and the outlet in various embodiments, the flow velocity is increased, creating some mixing flow in the body of the reactor vessel and making the solution flow more turbulent. This may enable all portions of the water to have sufficient time within the active treatment distance from the UV light sources and prevent portions of the solution from flowing through the reactor only within these dead spaces or without sufficient time in treatment proximity to the UV light sources.

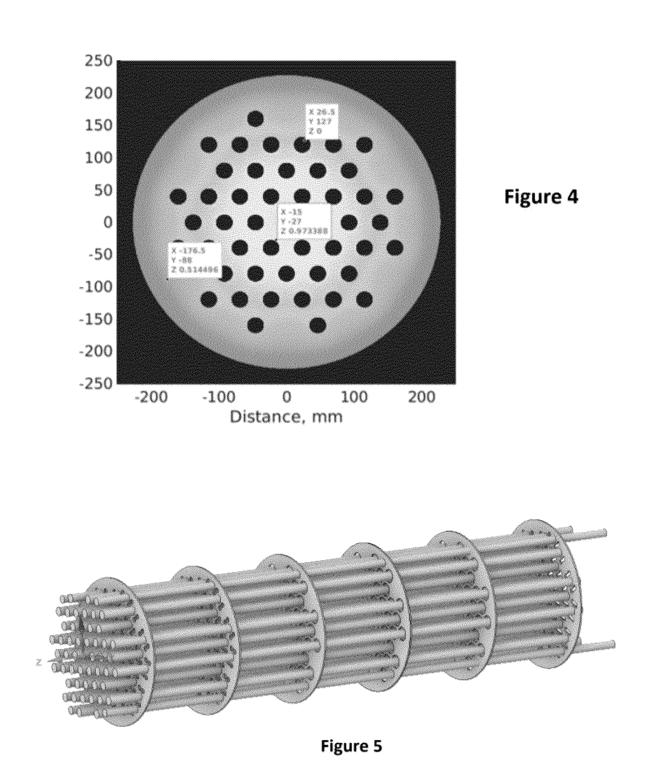

A cross sectional representation of the UV light sources within a horizontal cylindrical pressure vessel photoreactor is shown in FIG. 4. Other spacing and configuration of the UV light sources may alternatively be used. The light sources are bulbs which are located within transparent sleeves, both of which are narrow and elongated and extend from one end of the vessel to the other, arrayed in an evenly spaced side by side arrangement throughout the interior of the vessel. This spacing allows wastewater to flow between the sleeves containing the bulbs, at a distance and flowrate to allow for high levels of PFAS destruction. However, additional features of the vessel also cause wastewater flow to be turbulent, such that all water is in close enough proximity to the bulbs for a sufficient time for PFAS destruction without passing through the vessel untreated, such as within treatment dead spaces, with turbulent flow providing mixing such that wastewater does not pass through the vessel without sufficient time in the treatment zones around the lamps.

The turbulent flow may result from several factors. One factor which creates the more turbulent flow is the use of a substantially narrowed inlet, in combination with a sharp and rapid increase in cross section diameter as the wastewater enters the vessel. The rapid deceleration of flow upon entering the vessel may result in turbulence and recirculating flow. In addition, the wastewater enters the vessel in a direction perpendicular to the longitudinal axis, through which the wastewater travels, causing addition flow disruption. There are also elements within the vessel which act as baffles, further interrupting flow to create a more turbulent flow of wastewater through the vessel.

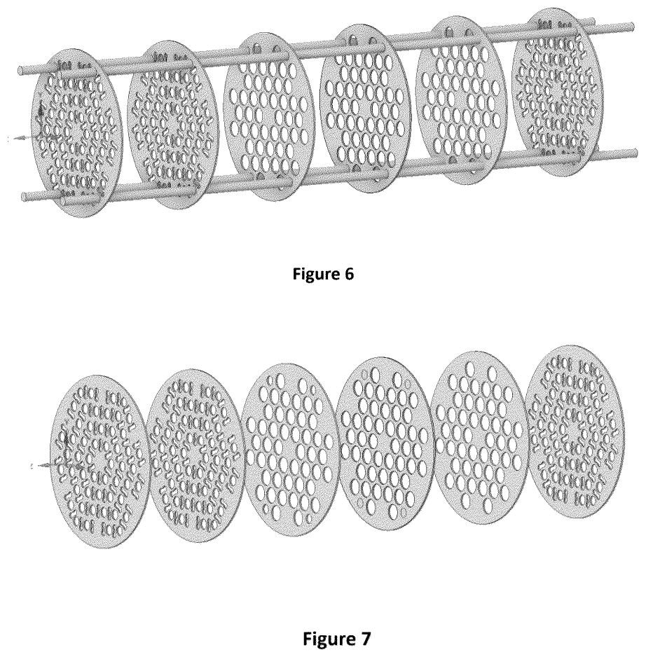

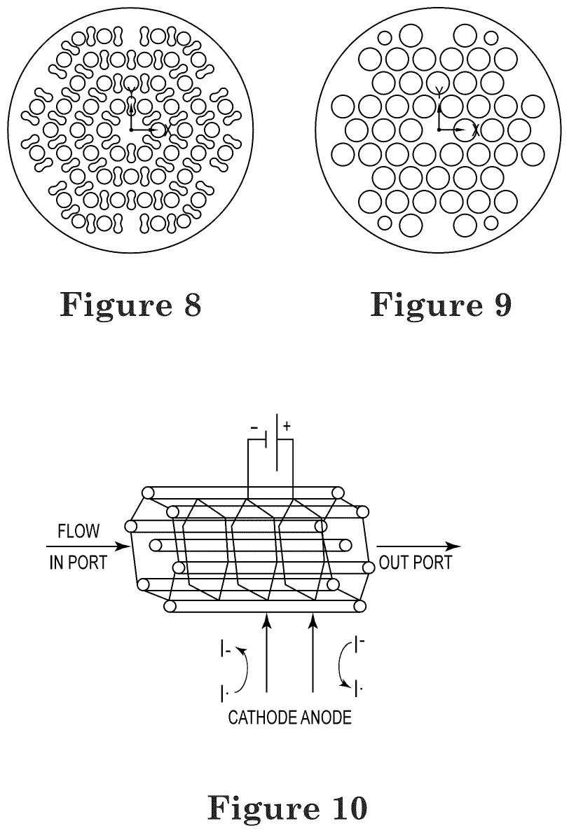

FIGS. 5-9 show the UV light support system or frame which is located within the tube photoreactor. FIG. 5 shows a perspective view of the UV light support system which include a plurality of perforated disks through which the lamp sleeves extend, as well as 4 support rods. In this example there are 6 perforated disks, though there could alternatively be more or less. The perforated disks are rigid, thin, spaced apart and coaxial. When positioned inside the tube reactor, the disks extend to the reactor walls, with the outer circumference abutting the inside surface of the reactor walls, such that wastewater must flow through the perforations under pressure from the pump in order to traverse the tube reactor. FIG. 6 shows the spaced plurality of perforated disks of FIG. 5, but without the lamp sleeves and only the support rods present. In this example, there are two different configurations of perforated disks, such that the perforations are not in alignment throughout the flow path from one end of the reactor to the other, as shown in the FIG. 7. As such, wastewater must travel a circuitous path through the perforations, rather than a direct straight path. A perforated disk having a first configuration as shown in FIG. 8, in which the perforations include two types of apertures. A first array of apertures are circular apertures sized to closely accommodate the lamp sleeves in an abutting alignment. A second array of apertures which are oval with widened ends (cassinian ovals) are located between the circular apertures and provide a passage for the wastewater, though other aperture shapes, numbers and configurations could alternatively be used. A perforated disk having a second configuration as shown in FIG. 9, with an array of circular apertures, larger than the circular apertures in the first configuration shown in FIG. 8, and no oval apertures or other apertures to provide a pathway for the wastewater. Rather, in the perforated disks like those shown in FIG. 9, the lamp sleeves extend through the larger circular apertures with a gap between the outside of the sleeve wall and the inner edge of the apertures, allowing space for wastewater to flow through the aperture around the bulb sleeve. There are also a plurality of smaller apertures (in this example four, though other numbers such as three or five could be used), through which the support rods extend to support and maintain the perforated disks in their positions and orientations. However, only the larger lamp sleeve circular apertures provide space for the passage for the wastewater through the disk, such that all of the wastewater that passes through the disks of the second configuration must pass in close proximity to the lamps. In this example, there are 48 circular apertures in each disk for the passage of the 48 lamps, though alternative embodiments could include more or fewer numbers of apertures and could have different arrangements. Likewise the numbers and arrangements of the two types of perforated disks may vary from that shown in this example, and additional or fewer types of perforated disks may be used. However, whatever the arrangement of perforated disks, it can be appreciated that they act as baffles which create additional turbulence within the reactor, ensuring that the water flow is turbulent to maximize wastewater exposure to the ultraviolet light.

In a UV system where a photosensitizer such as iodide and the UV photon generate a solvated electron and a radical such as an iodine radical, it may be beneficial to reduce the photosensitizer, such as the iodine radical, back to iodide because the iodine may efficiently scavenge solvated electrons. Iodide can absorb a UV photon and generate a solvated electron and the iodine radical as shown below.

$${I}^{-} + UV Photon à I \cdot and {e}_{aq}^{-} ( solvated electron )$$

The iodine radical may combine to form iodine (I₂). In the presence of iodide, iodine can further react to form the triiodide anion.

$$\begin{matrix}I \cdot + I \cdot à {I}_{2} \\ {I}_{2} + {I}^{-} à {I}_{3}^{-}\end{matrix}$$

The iodine radical, iodine, and triiodide are all efficient scavengers of solvated electrons. As such, if their concentration is allowed to build up in the reactor, it may reduce the efficiency of PFAS destruction because they will compete with PFAS for solvated electrons. This competition can be reduced by introducing a reductant like sulfite. Alternatively, or additionally, this competition can be reduced by electrochemically reducing the iodine radical, as described herein.

In some photochemical/electrochemical PFAS destruction systems such as batch systems, it may be advantageous to have the electrodes in separate compartments, which may be electrically connected by a membrane or an ionic bridge, for example. The cathode may be located in the photoreaction chamber, and the anode may be located outside of the photoreaction chamber. In this way, the iodine can be reduced near the cathode which is near the light source and iodide can be oxidized at the anode which is distant from the light source. The physical separation of the cathode and anode prevents or inhibits the iodine produced at the anode from diffusing to the cathode chamber such that it does not interfere with the photochemical destruction of the PFAS.

Alternative methods of regenerating photosensitizer may be particularly useful in continuous photoreactor systems in which the aqueous solution including PFAS continuously flows through the reactor, from and input to an output port throughout the UV treatment process, such as the continuous systems described herein. An example of this process is shown in FIG. 10. This example shows a continuous UV photoreactor system including an electrolytic system. A plurality of lamps are shown extending lengthwise through the continuous photoreactor. A plurality of cathodes are located within the reactor, in relative proximity to the input port, and a plurality of anodes, which are paired with the cathodes, are located in relative proximity to the exit port. As UV light is produced by the lamps and the photochemistry occurs within the reactor, solvated electrons and used photosensitizer, such as iodine, bromine, and/or chlorine are generated. The used photosensitizer, such as iodine, bromine and/or chlorine is electrochemically reduced to iodide, bromide, and/or chloride at the cathode for use in further UV photolysis of PFAS. As the treatment solution flows through the photoreactor and approaches the exit port, photosensitizer such as iodide is oxidized to iodine at the anode, to balance the reaction, and is then swept out of the photoreactor with little or no negative impact on UV photolysis of the PFAS in the wastewater.

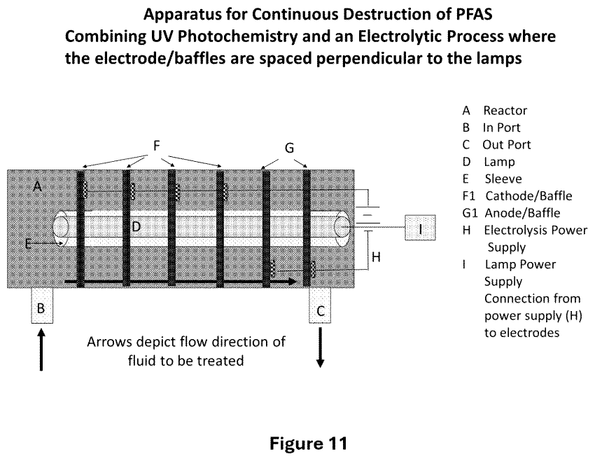

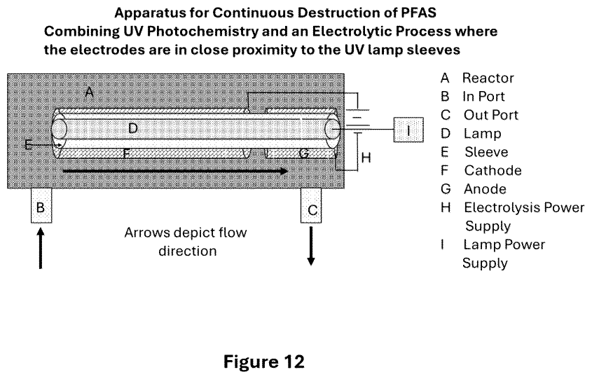

The use of continuous photoreactor systems allows for the electrochemical regeneration of photosensitizer without the physical separation of the anode and cathode in separate chambers, due to the flow of the aqueous solution through the photoreactor. In a continuous process there are various configurations that can minimize the interference of the oxidized products produced at the anode. Two non-limiting reactor configurations are shown schematically in FIG. 11 and FIG. 12. Although these figures show a single lamp extending through the center of the photoreactor, it should be understood that this is for demonstration of the concept only. In actual practice, a plurality of lamps, like the single lamp shown in these examples, may extend through the photoreactor. Furthermore, while the figures and discussion may refer to photosensitizers including halogens such as iodide, the systems and methods are not limited to iodide or other halogens as the photosensitizer. Rather, any photosensitizer which acts as a source of solvated electrons, such as any of those discussed in this application as well as others, could be used in various embodiments with reduction of the photosensitizer occurring at the cathode as described herein.

In both configurations shown in FIGS. 11 and 12, the water to be treated flows through the reaction chamber. One or more cathodes may be arranged upstream within the reactor, closest to the inlet, such as within the first 50 percent or more of the photochemical chamber length, or within the first 80 percent or more of the photochemical chamber length, or within the first 90% or more of the photochemical chamber length. One or more anodes may be located downstream of the cathodes, closer to the chamber outlet or beyond the chamber outlet, such as within the last 50% or less of the photoreactor chamber length, or within the last 20% or less of the photoreactor chamber length, or within the last 10% or less of the photoreactor chamber length, or beyond the chamber outlet such as immediately outside of the chamber. The above discussion may be relevant to photochemical chambers in which the UV lamps extend and/or are located throughout the entire length of the photochemical chamber, such that the above locations (such as the first 50 percent of the photochemical chamber length) may apply to both the chamber and the portion of the UV lamps within the chamber. Alternatively, in photoreactors in which the UV lamps do not extend and/or are not arrayed throughout the full length of the photoreactor, the above description may apply instead to the length or extent of the UV lamps within the chamber. For example, one or more cathodes may be arranged upstream within the reactor, closest to the inlet, such as in the first 50 percent or more of the length or array of UV lamps, or within the first 80 percent or more of the length or array of UV lamps, or within the first 90% or more of the length or array of UV lamps. One or more anodes may be located downstream of the cathodes, closer to the chamber outlet or beyond the chamber outlet, such as in the last 50% or less of the length or array of UV lamps, or in the last 20% or less of the length or array of UV lamps, or in the last 10% or less of the length or array of UV lamps, or beyond the length or array of UV lamps, within or outside of the chamber. In some embodiments, one or more or all of the anodes may be located downstream of the UV lamps, in the section of reactor beyond the UV light and not being exposed to the UV light or exposed to less UV light.

An example of a continuous photoreactor including cathodes and anodes for electrochemical reduction of iodine is shown in FIG. 11. The photoreactor shown in FIG. 11 includes a plurality of perforated baffles which extend across a cross sectional area of the photoreactor chamber, like the baffles shown in FIGS. 5-9. As described above, baffles may be used in photoreactors to ensure efficient mixing of the wastewater. The baffles may be located at spaced intervals along the reactor length to increase turbulent flow. In the case of the system shown in FIG. 10, the one or more or all of the baffles also serve as electrodes or, alternatively, as supports for electrodes which may be located on and connected to the baffles. The baffles may be oriented perpendicular to the elongated UV lamps, as in this example. This orientation provides a benefit of minimizing the amount of light that is absorbed by or obstructed by the baffles. Additionally, the baffles may be made partially or entirely of a conductive materials, such as metal, metal oxide, graphite, diamond, composite materials of metal, graphite, carbon nanotubes, graphene or conductive polymer, or allotropes of carbon (graphite, graphene, carbon nanotubes) that may act an electrode or an electrode portion of the baffle.

In alternative embodiments, a mesh electrode such as a metal mesh electrode may be supported by one or more of the baffles. In such embodiments, the baffles may not be conductive.

In other embodiments, one or more or all of the baffles may be made partially or entire of a mesh such as a metal mesh that may be conductive, such that the baffles may act as both a baffles to promote turbulent flow through the photoreactor vessel and as electrodes. The metal mesh that may act as both a baffle and an electrode may be located at spaced intervals, approximately perpendicular to the light sources. In such embodiments, the aqueous solution including PFAS, photosensitizer and reagents must flow through the open spaces of the mesh, in close proximity to the conductive mesh material, as it traverses the photoreactor from the inlet to the outlet. The perpendicular orientation may be a preferred configuration for some embodiments, while other non-perpendicular orientations of the electrodes to the lamps may alternatively be used in other embodiments.

Several embodiments of this system may incorporate electrodes with a conducting surface area much larger than their 2-D surface area, such as a mesh, which may optionally be incorporated into a baffle or other support. When incorporated into a baffle or other support, the baffle or other support may also serve to support the lamps at various points along the long axis of the reactors and/or mix the wastewater treatment solution as it flows through the reactor. Such an embodiment may include a disk shaped baffle with a system of apertures to encourage turbulence of the wastewater treatment solution flowing through the apertures, with a metal conducting mesh extending across the apertures. In other embodiments, one or more of the baffles could be entirely made of a conductive mesh extending across a cross section of the reactor. In yet other embodiments, a conductive mesh or other conductive and permeable material could be incorporated into the reactor system and fill the space of the reactor, or one or more separate cross sectional spaces (like a slide or segment) of the reactor perpendicular to the longitudinal axis through which the wastewater treatment solution flows, independent of the baffles.

In various embodiments in which the baffles extend across the entire cross sectional area of the photoreactor, the aqueous solution including PFAS must pass through the apertures in the baffles in order to flow from the inlet to the outlet. These apertures may be provided as apertures within an otherwise continuous solid baffle and/or from apertures formed by the mesh material of the baffles. In this way, the aqueous solution flows through the apertures in close proximity to the conductive material which may form the baffle and/or the portion of the baffle surround and/or the electrode extending over and/or around the apertures, for example.

Another embodiment of a continuous photoreactor includes cathodes and anodes for the reduction of iodine is in FIG. 12. In this example, the electrodes are located in close proximity to the lamps, such as in contact with and surrounding the lamps' sleeves. In one embodiment like in the embodiment shown, the electrodes may be in contact with the lamp sleeves, for example wrapped around the lamp sleeves, such as in a spiral fashion or as a wrap around a portion of the length of the lamp sleeve. The electrodes may also be supported by spacers extending from the lamp sleeves and separating the lamp sleeves from the electrodes by between about 0 or 0.5 cm and about 5 cm, or between about 0 or about 0.5 cm and about 3 cm. The electrode could be in the form of a wire or a wire mesh, for example.

The electrode may be configured so that the majority, such as greater than about 50%, or greater than about 75%, or greater than about 90%, of the light is not obstructed by and/or absorbed by the electrode. In some embodiments, the electrode may obstruct and/or absorb less than about 10% of the light, or less than about 5% of the light produced by the lamp with which it is associated. When the electrode is located in close proximity to the lamp, there may be a tradeoff between the surface area of the electrode and the light obstruction and/or absorption of the electrode. As such, if the electrode is close to the lamp or lamp sleeve, an electrode of less surface area may be used.

In systems and methods in which a photosensitizer is used, the concentration of the photosensitizer may be considered with regard to the distance at which the electrode is spaced from the lamp sleeve and the amount of light is absorbed at that distance. For example, if the photosensitizer of a given concentration absorbs 90% of the light within one centimeter, a dense mesh may be placed at 1 cm or more distance from the lamp while only reducing the effect of the light on the photosensitizer by at most 10%. At the same concentration of photosensitizer, an electrode located at 2 cm from the lamp sleeve would have even less impact, resulting in at most 1% absorption of the UV light.

The design of a continuous photoreactor including photochemical/electrochemical systems as described herein may depend on the materials used to construct the reactor. For example, if the body of the photoreactor is made of a conducting material like stainless steel, in systems in which the baffles are themselves electrodes, the baffles may be insulated from or sufficiently separated from the body of the reactor. For example, the baffles could be designed, sized and/or positioned in such a fashion as to not contact the photoreactor wall and/or to be insulated from the reactor wall by an insulator. Suitable insulators may include non-electrically conducting material such a plastic, glass, or ceramic. The outer circumference of the baffle and/or the inside of the reactor wall may be insulative material, such as entirely lining the inside of the reactor wall or in at least the portions of the inside of the reactor wall that contact the outer periphery of the conductive baffle electrodes. In addition, the potential conductivity of other components must be considered. For example, the rods or other supports that support the baffles and/or lamps may be made of a conductive material. In such cases, the support may include insulative material to prevent conduction by the rods, such as at the locations where the rods contact the baffles. In this way, the conductive baffles are electrically separate from each other.

In some embodiments photoreactors including a photochemical/electrochemical system including electrodes, the electrodes may be electrically insulated from the reactor such as from the reactor wall. In some embodiments, metal support rods are affixed to the reactor ends of the reactor. In such embodiments, the support rods may extend parallel to the long axis of the reactor and perpendicular to the baffles and can be used to support the baffles such that the baffles are electrically isolated from electrical contact on the walls of the reactor. Such metal support rods may pass through electrically insulating material such as gromets as they pass through the baffles. Electrically insulating gromets may be used to electrically isolate the support rods from conductive contact with the reactor wall at the support rod ends.

Likewise, if electrodes are used other than baffles, these electrodes must also be electrically isolated from each other, as well as from the photoreactor wall, the support rods, the baffles, and any other conductive material, such as through the use of insulators which may be at locations of contact such as at contact or connection points. For example, in some embodiments, such as embodiments in which the anode and cathode protrude from the inside of the reactor vessel wall, electrically insulating gromets could insulate the anodes and cathodes from the reactor wall, so that the electrochemical current is not grounded at the reactor.

In alternative embodiments, the photoreactor wall may be made of a nonconductive material such as glass. A photoreactor made of a nonconductive material may not require the use of an insulator between the baffles and the reactor wall. Similarly, if the support rods holding the baffles and laps is a nonconductive material, insulative material may not be required between the baffles and the support rods.

The examples shown in FIGS. 11 and 12 are just two examples of how the electrolytic process may be employed in a continuous photoreactor. Other configurations may also be effective. For example, a photoreactor which is a hybrid of FIGS. 10 and 11 may have electrodes which are incorporated into and/or formed by the baffles and also associated with the lamps or lamp sleeves and/or located elsewhere. Other embodiments may include other configurations of the electrodes, such as electrodes extending from and supported by the photoreactor vessel wall structure, which may extend towards the center of the reactor.

In various embodiments, the cathodes may all be at the same potential or may be different potentials. In embodiments in which the electrodes are used to reduce the oxidized photosensitizer, the potential would be sufficient to reduce the oxidized photosensitizer back to the photosensitizer.

The anode and the cathode pairs may be connected through one or more power supplies. Additionally, the cathodes may operate under a constant current regime. The electrolytic reaction may be performed continuously or intermittently. The current may be continuous or pulsed.

The PFAS containing wastewater should have sufficient ion content to allow current to efficiently flow between the anodes and the cathodes. When sufficient ion content is present in the wastewater, no additional ions may be needed as electrolyte. However, when sufficient ion content is not present in the wastewater, additional ions may be added to the wastewater, such as prior to the photoreaction. In some cases, for example, when the pH of the wastewater is around pH=12, little or no extra electrolyte would be required. In other cases, electrolytes such as sodium sulphate, potassium sulfate, sodium chloride, potassium chloride, sodium bromide, potassium bromide, sodium phosphate, potassium phosphate, sodium hydroxide, or potassium hydroxide may be added to the wastewater treatment solution. For example, electrolytes may be added to achieve an ion concentration of 10⁻³ M or more, if not already present, such as if not already present due to the addition of base, photosensitizer and reagent to the wastewater.

These systems may lower the concentration of oxidized photosensitizer such as iodine in the photoreactor resulting from UV photolysis by reducing the oxidized photosensitizer such as iodine at the cathodes. In addition to reducing the oxidized photosensitizer, the photochemical/electrochemical system may also reduce other electron scavengers that may be present in the wastewater, lowering their concentrations and their impact on the PFAS photolysis reactions. The cathodes may perform additional reactions beyond the reduction of iodine or triiodide that may be beneficial. For example, nitrate, dissolved oxygen, and protons may all be present in wastewater and may all act as electron scavengers. A cathode operating at potential sufficient to reduce nitrate, dissolved oxygen, protons, or other electron scavengers could be used to decrease the concentration of electron scavengers in the solution in order to increase the efficiency of PFAS destruction.

In addition to reducing iodine at the cathode, other chemistry may be performed. For example, as in the U.S. patent application Ser. No. 18/771,229, entitled Methods and Systems of Photo-Electrochemical PFAS Destruction, filed Jul. 12, 2024, and hereby incorporated by reference, protons may be reduced to form hydrogen gas. As a result, the wastewater around the cathode may become depleted of protons and the pH may be raised. A high pH environment for the destruction of PFAS in an Advanced Reductive Process is favored because a low concentration of protons reduces the likelihood that the solvated electron will react with protons and thereby lessen the efficiency of PFAS destruction process.

Hydrogen gas that may be generated at the cathode may be useful at various wavelengths. For example, various embodiments may electrochemically form hydrogen gas during photolysis in a photoreactor with UV lamps producing light at a wavelength peak of approximately 185 nm. In such embodiments, irradiation with light at 185 nm generates hydroxyl radicals. In the presence of electrochemically produced hydrogen gas, hydroxyl radicals may react with hydrogen and generate a hydrogen radical that, under basic conditions, can form solvated electrons. In embodiments in which hydrogen is generated at the cathode, an oxidative process would occur at the anode. In water solutions, the water may be oxidized to oxygen. Since oxygen has a high reactivity with solvated electrons, the cathode and anode may be physically separated from each other. However, in a continuous photoreactor, if the oxygen is generated at an anode located downstream in the photoreactor as in the systems described herein, such as at or near the exit port of the photoreactor, the oxygen may be swept out of the photoreactor without accumulating or interfering with the photolysis of the PFAS within the reactor. In such a system, the electrodes may be a conductive material such as metal, metal oxide, graphite or diamonds or a composite materials of metal, graphite, carbon nanotubes, graphene or conductive polymer. In some embodiments, preferred electrode compositions may include metal, diamond or other allotropes of carbon (graphite, graphene, carbon nanotubes).

In some embodiments, continuous photoreactor systems like the one described above, or other photoreactor systems, such as those described herein or other systems, may be used to achieve very low levels of PFAS, with high levels of PFAS destruction, even when initial PFAS levels are very low. For example, PFAS levels may be reduced to zero or nearly zero, such as less than about 50 ppt, such as between zero and 50 ppt or between greater than zero such as 1 ppt and 50 ppt. These results may be achieved through the use of surprisingly low levels of photosensitizer system reagents, which was not previously recognized and is an unexpectedly effective process.

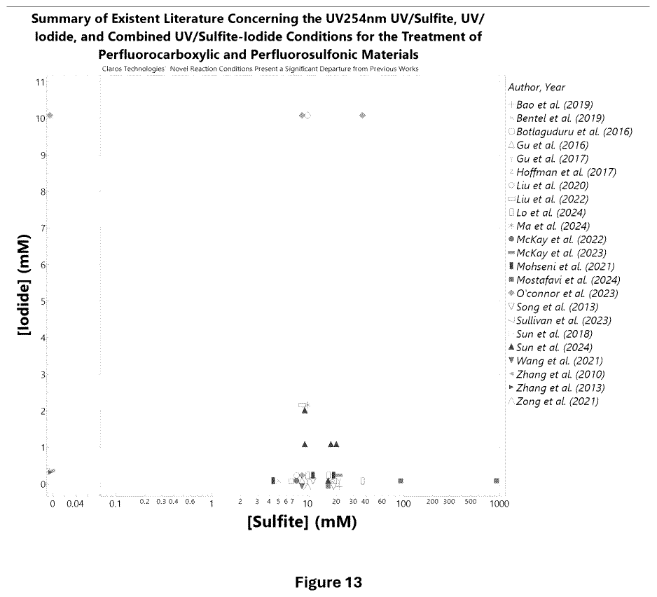

As shown in FIG. 13, references that teach the use of a combination of sulfite and iodide in UV treatment of PFAS teach the use of sulfite and iodide higher levels. However, these levels have now been discovered to result in lower levels of PFAS destruction and less efficient PFAS destruction when PFAS levels are very low. FIG. 13 presents a summary of PFAS treatment with UV light and sulfite, UV light and iodide, and UV light and sulfite and iodide for the destruction of perfluorocarboxylic and perfluorosulfonic materials under UV 254 nm irradiation in the literature. In comparison, a superior level of PFAS destruction may be achieved through the use of lower levels of sulfite and iodide, demonstrating that the novel conditions described herein are significantly differentiated from other methods.

FIG. 13 demonstrates that higher dosing schedules have been reported in the literature. A literature review consisting of greater than 20 publications concerning 254 nm UV treatment with sulfite, UV treatment with iodide and UV treatment sulfite and iodide for the degradation of perfluorocarboxylates and perfluorosulfonates is presented in FIG. 13, where the lower end of sulfite levels was observed at 10 mM for UV treatment with sulfite and iodide. In a stark departure from the novel conditions disclosed herein, recent literature supported that the use of significantly higher concentrations of sulfite, from 100 to 200 mM, was desirable to achieve better degradation kinetics. In UV treatment with sulfite and iodide systems, the concentration of the iodide spans from 1 mM to 10 mM. Meanwhile, in systems using pure UV treatment with iodide, concentrations between 0.25 and 10 mM, though the system performance with lower iodide dosing was far from satisfying (e.g., 4.4% defluorination of PFOA over 1.5 hours). Unlike UV treatment systems which used only iodide, the presence of sulfite in combination with iodide as used in various embodiments described herein, results in a fundamentally different UV-based photoreduction processes. The low levels of sulfite and iodide used in various embodiments for the treatment of very low levels of PFAS optimized provides a surprising and unpredictable improvement to the system's kinetic performance.

Various embodiments include systems and methods for destroying PFAS including exposing a solution of PFAS containing a mixture of iodide and sulfite and at a pH of about 9 or higher to ultraviolet light from one or more bulbs. The levels of iodide and sulfite may be controlled, such as by addition or reduction of iodide and/or sulfite in the solution, such that greater than about 90 percent, or greater than about 95 percent, or greater than about 99 percent, or about 99.9 percent, or about 99.99 percent of the PFAS in the solution is destroyed. For example, the initial levels of PFAS in the solution may be between about zero or about 50 ppt and about 12.5 ppm, or between about zero or about 50 ppt and about 10 ppm, or between about zero or about 50 ppt and about 5 ppm, or between about zero or about 50 ppt and about 2.5 ppm, or between about zero or about 50 ppt and about 500 ppb. The concentration of PFAS may be reduced to less than about 100 ppt, or less than about 50 ppt, for example. The methods and systems may include the use of a photoreactor that is a continuous flowing reactor wherein the rate of continuous flow influent into the reactor is equal to the rate of continuous flow of effluent out of the reactor during the photolysis process, such as the continuous flowing reactors described herein, or other reactors. In some embodiments, sulfite is the principal sacrificial reductant, and it is necessary to supply two electrons ultimately derived from sulfite to cleave one carbon-fluorine bond. The concentration of the carbon fluorine bonds is equal to the number of carbon fluorine bonds in a PFAS molecule multiplied by that molecule's concentration. The total carbon fluorine bond concentration is the sum of that product for all PFAS species in a solution. For example, in the case of PFBA, which has 7 carbon fluorine bonds, in this embodiment, for a solution containing 10 micromolar PFBA it would take 140 micromolar sulfite at a minimum to for complete mineralization. In various embodiments sulfite salt may have a concentration of a minimum of 0.1 mM to a maximum of 10 times the concentration of carbon fluorine bonds.

At very low levels of PFAS, the use of low levels of photosensitizer system reagents may result in higher levels of PFAS destruction and less energy consumption than higher levels of photosensitizer system reagents. As such, the amount of photosensitizer system reagents added to the PFAS solution may be very low when the initial PFAS concentration is low. Alternatively, if the photosensitizer system reagents are already present in the solution, a portion of the reagents may be removed from the solution to reduce the levels of reagents, such as after a sufficient amount of PFAS is destroyed such that the PFAS levels are very low. In some embodiments, the initial PFAS containing solution may be a solution which was not previously treated for PFAS removal. In other embodiments, the initial PFAS solution may be a solution which was previously treated for PFAS removal, including methods of PFAS destruction using UV light and a photosensitizer system including iodide and sulfite, as well as other methods. These methods may have been performed separately or may have been performed immediately before the methods described herein, such as in a sequential manner. However, the previous treatment processes may have reduced the PFAS to very low levels, such as less than 500 ppb, or less than 1 ppm such as between about 500 ppb and 1 ppm, or less than 2.5 ppm such as between 500 ppb and 2.5 ppm. Alternatively, these levels may be the levels of PFAS present in the solution without prior treatment or reduction of the PFAS levels.

In some embodiments, the destruction of PFAS may include two PFAS treatment steps. A first PFAS treatment step may be performed to lower the PFAS to less than about 12.5 ppm, or less than about 10 ppm, or less than about 5 ppm, or less than about 1 ppm, for example, such as by using a UV photoreactor, such as a UV photoreactor system or process described herein. The first PFAS treatment step may include the use of a photosensitizer system that may include iodide, sulfite, and/or base, for example. In the photosensitizer system, generally the iodide may act as a sensitizer while the sulfite may act as a sacrificial reductant to reactivate and maintain the effectiveness of the iodide. In some cases, however, such as when high sulfite concentrations are used, the sulfite may also act as a photosensitizer.

Following the first PFAS treatment step, such as after the treatment solution exits the reactor, the level of reagents in the photosensitizer system in the treatment solution may be adjusted. The amount and direction of adjustment may depend upon how much of the reagent is present in the treatment solution after the first treatment step. For example, if all of the reagent was consumed during the first treatment step, additional reagent such as iodide or sulfite may be added to the treatment solution to achieve the desired low reagent levels as described herein. For example, the methods and systems may include metering low levels of sulfite and/or iodide into the treatment solution if the photosensitizer system reagent levels are too low. Alternatively, if excess photosensitizer system reagents remains in the treatment solution following the first treatment step, a portion of or all of one or more of the reagents may be removed from the treatment solution, to achieve the desired low photosensitizer system reagent levels as described herein. For example, some or all of the iodide or sulfite may be removed. For example, air or oxygen may be added to the treatment solution to reduce or remove sulfite. The treatment solution may be passed through or contacted with an exchange media such as an anion exchange media or membrane to remove iodide. In some embodiments, the sulfite and/or the iodide may be electrochemically oxidized or reduced to reduce or remove it from the treatment solution. Alternatively, if the levels of photosensitizer system reagents in the treatment solution are sufficiently low after the first PFAS treatment step, no adjustment of reagent level may be needed, and this step may be omitted.

The treatment solution with the desired low levels of photosensitizer system reagents may then be treated using the second PFAS treatment step. The actual low level of photosensitizer system reagents included in the solution may depend upon the level of PFAS present in the solution, as described further below and as shown in the Examples. Like the first PFAS treatment step, the second PFAS treatment step may be performed in a UV photoreactor like those described herein or in other UV photoreactors. In some embodiments, the first and second PFAS treatment steps may be performed in separate reactors, which may be the same or different, in a serial configuration. In other embodiments, they may be performed in the same reactor, with the treatment solution remaining in the reactor and adjustment of the photosensitizer system levels occurring within the reactor (if necessary), or with the treatment solution exiting the reactor and then cycling back through the reactor for a second treatment step, for example.

In still other embodiments, the consumption of photosensitizer system reagents during a UV treatment process may be balanced by the destruction of the PFAS, such that as the PFAS levels fall to low levels, the photosensitizer system reagents likewise are consumed to achieve the desired low levels described herein. In such embodiments, a single PFAS treatment step may be used, with the desired levels of photosensitizer system reagents being achieved to match the PFAS levels during the treatment process such that the treatment process can continue with PFAS destruction from high levels to very low levels without interruption.

PFAS level requiring the very low photosensitizer system reagent levels described herein may be referred to as the “initial” PFAS level or “initial” photosensitizer system reagents level. However, it should be understood that this initial level may include not only a starting PFAS level or photosensitizer system reagent level before treatment but also at the PFAS level or photosensitizer system reagent level at the start of any one of a series of PFAS treatment steps, such as prior to and/or upon flowing into a reactor (whether a first or subsequent reactor) such as immediately before UV treatment. Furthermore, the PFAS levels and the corresponding desired initial levels of photosensitizer system reagents also apply to PFAS levels and photosensitizer system reagent levels which occur during a PFAS treatment process, even if their initial levels were higher.

When discussing desired photosensitizer system reagent levels below and elsewhere herein, the PFAS solution is generally considered as being free of oxygen. Wastewater may include varying levels of oxygen. Furthermore, oxygen removal may be achieved by various means. As such, the amount of a chemical or other material used for oxygen removal may vary. Therefore, it is useful to consider the photosensitizer system reagent levels required for PFAS treatment separately from removal of oxygen. However, in some embodiments, sulfite may be used for the removal of oxygen, with the amount of sulfite dependent upon the oxygen levels present in the solution. In such embodiments, the sulfite levels provided below and elsewhere herein may be increased by the amount of sulfite required to remove the oxygen, such as between about 0.01 mM and about 1 mM, or between about 0.05 mM and about 0.8 mM, or between about 0.1 mM and about 0.7 mM, or between about 0.3 mM and about 0.6 mM sulfite.

Various embodiments may include the use of low dose halide, such as bromide or iodide, and sulfite for the destruction of PFAS using UV light with a maximum or peak intensity intensity or photon fluence between 200 and 250 nm, such as at about 222 nm. Photo-generated solvated electrons, produced when a photo-sensitizer (typically a halide ion or a sulfite ion) absorbs a UV photon, reductively cleave carbon-fluorine bonds. Reducing agents such as sulfite can be used in this method as a sacrificial reductant to reduce a radical halide back to its ion after electron ejection. The vast majority of studies to date have focused on the use of iodide as a photo-sensitizer. Iodide is the only halide ion that absorbs significant light at 254 nm, (molar extinction coefficient ~256 L mol⁻¹ cm⁻¹), the peak wavelength of a low-pressure mercury lamp, and has a significant quantum yield for electron generation of 0.176.

Other halide ions such as bromide and chloride absorb light at energies higher than 254 nm, and can serve as a potential source of solvated electrons for PFAS destruction. Bromide absorbs light at 222 nm, which is the peak energy output of a krypton-chloride excimer lamp. Its molar extinction coefficient is approximately 77 L mol⁻¹ cm⁻¹ at this wavelength, and it has a quantum yield for electron ejection of 0.343. At 254 nm sulfite absorbs very little light (decadic extinction coefficient approximately 50 M⁻¹ cm⁻¹), yet at 222 nm, sulfite absorbs approximately 20 times more light than does bromide (1665 L mol⁻¹ cm⁻¹:77 L mol⁻¹ cm⁻¹) and has a free electron yield of approximately 0.264. Thus, sulfite will contribute significantly to the concentration of solvated electrons at 222 nm. Sulfite also serves as a potent electron scavenger with a second order rate constant for scavenging free electrons of approximately 106 L mol⁻¹ s⁻¹ (sulfite) vs. approximately 10³ L mol⁻¹ s⁻¹ (bromide), and it serves as a sacrificial reductant to reduce bromine radical to bromide post electron ejection. Additionally, a sodium hydroxide base used to establish the pH absorbs light at 222 nm whereas it does not absorb light at 254 nm. Thus, the interaction among the reagents at 222 nm is complex, making the ultimate performance during photolysis difficult to predict. In some embodiments, the UV-based advanced reduction process can be carried out under 222 nm UV illumination using sulfite as the photosensitizer and the chemical reductant.

Various embodiments include the use of bromide and sulfite for photolysis of PFAS using UV irradiation at 222 nm. Low concentrations of bromide may be more effective than higher concentrations in the treatment solution. In some embodiments, the concentration of bromide in the treatment solution may be between about 0 mM to about 40 mM, or between about 1 mM to about 40 mM. In some embodiments, both sulfide and bromide may be included in the treatment solution and the ratio of bromide concentration to sulfite concentration may be between 0.1 to 100 or 1.12-80. In some such embodiments, the pH of the treatment solution may be about 9 or greater, such as 9 to 12.5. Greater than about 90% or more of PFAS may be destroyed, or greater than about 95%, or greater than about 99%, or greater than about 99.9%, using bromide and sulfite for photolysis of PFAS at 222 nm. These high levels of PFAS destruction may be achieved using batch photoreactor systems or continuous reactor systems such as those described herein. The bromide and sulfite photoreactor process for PFAS destruction at 222 nm may be used in combination with various pretreatments and/or posttreatments and/or in combination with other photoreactor processes.

Various embodiments include the use of iodide and sulfite for photolysis of PFAS using UV irradiation at 222 nm. Low concentrations of iodide may be more effective than higher concentrations. In some embodiments, the concentration of iodide in the treatment solution may be between about 0 micromolar to about 200 micromolar or between about 1 micromolar to about 200 micromolar or between about 2 micromolar to about 100 micromolar such as between 50 micromolar to about 100 micromolar. In some embodiments, both sulfite and iodide may be included in the treatment solution and the ratio of iodide concentration to sulfite ratio may be between 0.001 to 1, or 0.0016 to 0.2. In some such embodiments, the pH of the treatment solution may be about 9 or greater. Greater than about 90% or more of PFAS may be destroyed, or greater than about 95%, or greater than about 99%, or greater than about 99.9%, using iodide and sulfite for photolysis of PFAS at 222 nm. These high levels of PFAS destruction may be achieved using batch photoreactor systems of continuous reactor systems such as those described herein. The iodide and sulfite photoreactor process for PFAS destruction at 222 nm may be used in combination with various pretreatments and/or posttreatments and/or in combination with other photoreactor processes.

An effective system for photochemically destroying PFASs may include pretreatment, then photolysis, then post-treatment, then optionally a polishing step, for example. For example, various embodiments may include methods and systems for pretreatment including electrochemical pretreatment, nitrate pretreatment, filtration pretreatment, organics pretreatment, reagent pretreatment, metal complex pretreatment, solids pretreatment, and/or oxidative pretreatment. Various embodiments may also include methods and systems for combination photochemistry/electrochemistry, recycling photosensitizer system reagents, 185 nm hydroxyl radical generation, non-mobile media reduction of byproducts, oxygen reduction, and/or alternative solvents. Various embodiments may also include post-treatment steps such as iodine/iodide/polyiodide recovery, PFAS removal, fluoride ion reduction, sulfate precipitation, and/or polishing steps.

In some embodiments, UV photolysis may be used in conjunction with an electrochemical system. This may be used alone or in combination with other methods of UV photolysis described herein, and the combination can further enhance the destruction rate of PFASs. An example of an electrolytic cell which may be used in combination with photochemistry is a photo-electrolytic cell in which the cathode is immersed in the electrolytic solution with the UV lamp. The photo-electrolytic cell may be used to reduce the photo-oxidized sensitizer back to the sensitizer to prevent the buildup of species that can react with solvated electrons. In other embodiments, the photo-electrolytic cell may be used to increase the pH around the electrode and therefore minimize the reactions of solvate electrons with protons. In still other embodiments, the photo-electrolytic cell may be used to produce hydrogen gas which, under some conditions, can increase the concentration of solvated electrons which can significantly increase the efficiency of photo-destruction of PFAS.

A photo-electrolytic device can increase the efficiency of PFAS destruction in multiple ways. As mentioned above, the photo-oxidized sensitizer may be electrochemically reduced back to the sensitizer. A photo-electrolytic device may also reduce the presence of scavenging species. For example, oxygen is an efficient scavenger of solvated electrons and interferes with destruction of PFAS. Lowering the levels of oxygen would be useful. Oxygen levels may be reduced by electrochemically reducing oxygen to less reactive species like water. In this case, the electrolytic reaction may occur before and/or during the photolysis. The replacement of fluorine on PFAS for hydrogen requires two electrons. The mechanism is believed to involve two separate one electron reduction steps. One or both of these electrons may be provided by reaction with a solvated electron, or a cathode in the case of a photo-electrolytic device.

Different systems and methods may be employed for each of these steps, in various combinations, and may be used in combination with the methods and systems described herein. All of the steps may be used in some cases, while in other cases the system or methods may not include all of these steps. Furthermore, the systems and embodiments may further include means for fluid transportation including pipes, pumps, valves, inlets, outlets, etc., such as connecting various components and connect to and from inlets and outlets of various components.

### EXPERIMENTAL

Examples 1-6 describe PFAS destruction by a UV-based advanced reduction process involving UV illumination at 254 nm and using sulfite and iodide at low concentrations. These examples demonstrate the ability to implement UV-based PFAS destruction in laboratory and industrial environments using empirical and model-based strategies.
Examples 7-14 exemplify PFAS destruction by a UV-based advanced reduction process extended to UV illumination at 222 nm using sulfite, bromide, or iodide in various combinations.
Examples 15-16 demonstrate the ability to improve PFAS destruction via integration of an electrolytic cell to a UV-based advanced reduction process involving UV illumination at 254 nm.

### Example 1

In this example, small-scale photoreduction experiments on industrial wastewater were used to demonstrate that lower reagent concentrations are beneficial in improving the degradation kinetics of perfluoroalkyl carboxylate (PFCA) such as perfluorobutane carboxylate (PFBA, C₃F₉—COO⁻). The wastewater was effluent which included additives from the production of fluoromaterials, and which had been previously filtered using granular activated carbon (GAC).

100 mL of wastewater was transferred into each of five 100 mL quartz vials (QP062, Aireka Scientific Co., Ltd, HK). The wastewater was then mixed with sodium sulfite (Na₂SO₃) and potassium iodide (KI) at the following reaction conditions: 10 mM Na₂SO₃ and 10 mM KI, 10 mM Na₂SO₃ and 2 mM KI, 5 mM Na₂SO₃ and 2 mM KI, 2 mM Na₂SO₃ and 2 mM KI, and 1 mM Na₂SO₃ and 1 mM KI. For all the reaction conditions, 20 mM NaOH was added to each solution to reach a final pH of 12. Finally, the loaded solution was photolyzed in a UV254 nm photoreactor (LZC-ORG type, Luzchem Research Inc. Canada, equipped with eight 10-watt UV254 nm lamps). 3 mL samples were taken from the quartz vials at 0, 2.5, 5, 7.5, 10, and 15 minutes for LCMS quantification of PFBA. The results are presented in FIG. 13, which shows PFBA destruction percentage vs. time at the tested reagent dosing conditions.

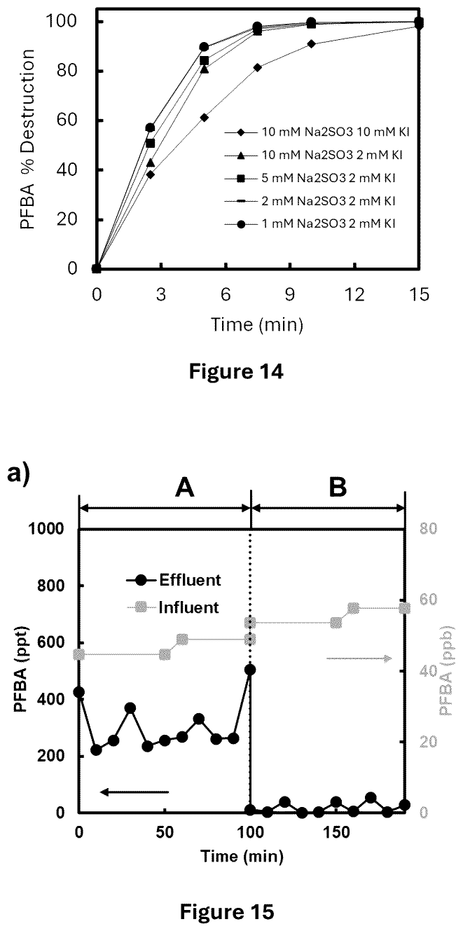

FIG. 14 shows PFBA destruction percentage at varied reagent dosing. Reagent concentrations for each data series are included in the plot. Destruction performance at 2 mM Na₂SO₃ and 2 mM KI conditions are nearly identical to 1 mM Na₂SO₃ and 2 mM KI and the data points overlapped on each other.

From FIG. 14, the lower reagent concentrations for UV254 nm photo-reduction resulted in faster kinetics and a higher destruction percentage. For instance, after 5 minutes photoreduction, 61% PFBA destruction was achieved at higher chemical dosing (e.g., 10 mM Na₂SO₃ and 10 mM KI). In contrast, when the photosensitizer system reagent concentration was reduced to 10 mM Na₂SO₃ and 2 mM KI, the PFBA destruction percentage increased to 81% after 5 minutes of photoreduction. With a further reduction of photosensitizer system reagents to 1 mM Na₂SO₃ and 2 mM KI, the PFBA destruction percentage increased to 90% after 5 minutes of photoreduction. Throughout the entire experiment, there was a general trend showing that the lower reagent concentration resulted in higher destruction percentage.

### Example 2

Photoreduction was performed on industrial wastewater at two different reagent concentrations using photoreactors at continuous mode. The wastewater was the same type of effluent as used in Example 1, but without GAC filtration. The photoreactors used in this example, referred to herein as the, were Aquafine Avant 48 reactors, modified as described herein with 0.75 inch inlet and outlet ports and referred to herein as the Continuous Flow Photoreactors. The results showed that lower reagent concentrations demonstrated a significantly higher PFBA percent destruction than the higher reagent concentrations.

In brief, 1200 L of wastewater in totes was mixed with two different concentrations of sodium sulfite (Na₂SO₃) and potassium iodide (KI) at two concentration levels: Condition A was the higher concentration level at 10 mM Na₂SO₃ and 5 mM KI, and Condition B was the lower concentration level at 1 mM Na₂SO₃ and 0.5 mM KI, demonstrating a 10× decrease in both reagent concentrations. In both conditions, 50% w/w NaOH solution was added to reach the final solution pH of 12. Finally, the loaded solution was photolyzed in the Continuous Flow Photoreactor at a continuous rate of 5 gallons per minute (GPM). 250 mL samples were taken from the reactor for Triple Quadrupole Mass Spectrometry (QQQ MS) analysis at varying time points. The results are presented in FIG. 15, which shows the influent and effluent PFBA concentrations vs. time at the two reagent dosing levels.

In FIG. 15, there is a difference in scale on the primary and secondary Y-axes. The influent PFBA concentration is plotted on the right gray Y-axis (in ppb), while the treated effluent PFBA concentration is plotted on the left black Y-axis (in ppt). The figure is separated by a vertical line in the middle, with results for condition A (10 mM Na₂SO₃, 5 mM KI) displayed on the left and condition B (1 mM Na₂SO₃, 0.5 mM KI) on the right.

As shown in FIG. 15, the lower reagent dosage (Condition B, 1 mM Na₂SO₃ and 0.5 mM KI) demonstrated better treatment performance and lower PFAS concentrations in treated effluent compared to the higher reagent dosage condition (Condition A, 10 mM Na₂SO₃, 5 mM KI). At the higher reagent dosage condition (Condition A, 10 mM Na₂SO₃, 5 mM KI), the effluent PFBA concentration averaged 309 ppt with an influent averaged 46.8 (44.6-49.0) ppb. At the lower reagent dosage condition (Condition B, 1 mM Na₂SO₃, 0.5 mM KI), the effluent PFBA concentration averaged 19.2 ppt with an influent averaged 55.7 (53.6-57.7) ppb, suggesting better kinetics at lower chemical reagent dosing.

### Example 3

In this example, the system's performance was tested at varied chemical dosing in a continuous operation mode at 5 gallons per minute through the Continuous Flow Photoreactor. At this flow rate, the continuous system demonstrated an average of 99.95% destruction of PFBA across four reaction conditions with approximately 20 hours of runtime and approximately 6000 gallons of industrial waste stream. The results also showed that the lowest reagent dosing resulted in the greatest destruction and lowest effluent PFBA concentration. The wastewater was the same type of effluent as used in the prior examples, including prior GAC filtration.

To prepare the influent waste stream for destruction, 1200 L of wastewater was added to a 1250 L tote and mixed with Na₂SO₃ and KI at four reagent dosing conditions listed in Table 1. The influent tote was then adjusted to pH 12 with 50% w/w NaOH.

TABLE 1
Reagent concentrations for each reaction condition A-D.

| | | |
|---|---|---|
| Reaction Conditions | Na₂SO₃ | KI |

| | | | | |
|---|---|---|---|---|
| A | 10 | mM | 2 | mM |
| B | 1 | mM | 2 | mM |
| C | 1 | mM | 1 | mM |
| D | 0.5 | mM | 0.5 | mM |

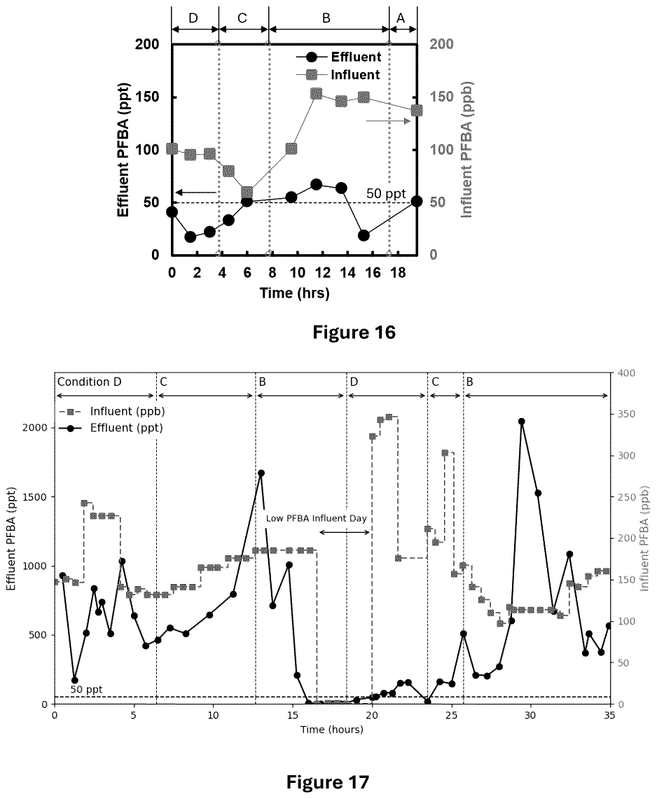

The results are shown in Table 2 and FIG. 16. FIG. 16 shows the influent and effluent PFBA concentrations at 5 GPM under the tested reaction conditions A-D. Note the scale on the right side of the graph (indicated in gray) is parts per billion (ppb) and the left side (indicated in black) is parts per trillion.

TABLE 2
Average influent and effluent concentrations of PFBA,
TFA, and 7H-Perfluoroheptanoic Acid at 5 GPM.

| PFAS | PFBA |
|---|---|
| Influent (ppb) | 59.3-105.9 |
| Effluent (ppb) | 0.042 ± 0.019 |
| Destruction Percentage (%) | 99.95 |

As shown in Table 2 and FIG. 16, the influent PFBA concentration ranged from 59.3-105.9 ppb, and the average effluent PFBA concentration was 42 ppt, demonstrating 99.95% destruction across all reaction conditions. FIG. 16 shows that the lowest reagent dosing, Condition D, resulted in the greatest destruction and lowest effluent PFBA concentration.

### Example 4

In this example, the performance was tested at varied chemical dosing in a continuous operation mode at 8.8 gallons per minute through the Continuous Flow Photoreactor. The influent wastewater was the same type as used in the previous examples, including prior GAC filtration. We tested three reaction conditions over approximately 35 hours with a highly variable influent stream. Our continuous system consistently demonstrated greater than 99.7% destruction of PFBA during the most optimal reaction conditions. The three tested chemical conditions are listed as Table 3.

TABLE 3
Reagent concentrations for each reaction condition B-D.

| | | |
|---|---|---|
| Reaction Conditions | Na₂SO₃ | KI |

| | | | | |
|---|---|---|---|---|
| B | 1 | mM | 2 | mM |
| C | 1 | mM | 1 | mM |
| D | 0.5 | mM | 0.5 | mM |

The influent and effluent concentrations were measured periodically and are shown in Table 4 and FIG. 17. In FIG. 17, the influent and effluent PFBA concentrations for the wastewater are shown for a treatment flow rate of 8.8 GPM. The wastewater used in this example is the same type as used in the previous examples, including prior GAC filtration. The influent PFBA concentration (ppb) on the right axis and the effluent PFBA concentration (ppt) on the left axis are plotted against time (hours). Each section corresponds to a reagent dosing condition D, C, or B. The 50 ppt dashed line corresponds to the effluent axis and associated data. The PFBA influent was particularly low during one time period, which is annotated as “Low PFBA Influent Day” from 16.5 to 20 hours on FIG. 17, and as B1 in Table 4. Condition B in Table 4 does not include the results for the Low PFBA Influent Day.

As shown in Table 4 and FIG. 17, the influent PFBA concentrations generally ranged from 96.8-303 ppb, and the average effluent PFBA concentration was about 400 ppt, demonstrating greater than 99.7% destruction for the two lowest reagent dosing conditions, C and D. During the Low PGBA Influent Day, the influent PFBA concentration ranged from 0.3-0.7 ppb. On this day, an effluent PFBA concentration of less than 10 ppt was achieved, demonstrating greater than 99% destruction. These results demonstrate successful, greater than 99% destruction of the target compound PFBA at 8.8 GPM across influent waste streams with wide variability in PFBA concentration.

TABLE 4
Average influent and effluent concentration of PFBA at 8.8 GPM.

| Condition | Influent PFBA (ppb) | Effluent PFBA (ppb) |
|---|---|---|
| D | 131.6-150.4 | 0.438 ± 0.340 |
| C | 140.8-303 | 0.421 ± 0.257 |
| B | 96.8-185.2 | 0.752 ± 0.568 |
| B¹ | 0.3-0.7 | 0.005 ± 0.010 |

¹Low PFBA Influent Day

### Example 5

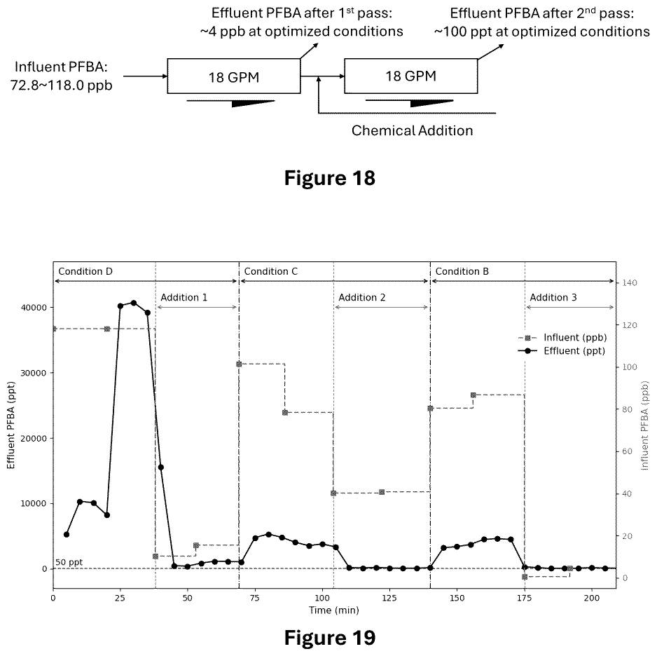

In this system, the continuous PFAS destruction system's performance was tested at varied chemical dosing in a continuous operation mode at 18 gallons per minute through the Continuous Flow Photoreactor with sequential treatment process. As shown in FIG. 18, we achieved 99.9% destruction of PFBA and produced an effluent concentration of approximately 100 ppt PFBA after the 2nd pass in the sequential treatment process. The wastewater was the same type as used in the above examples, including prior GAC filtration.

FIG. 18 shows a diagram of the 18 GPM sequential destruction process. As shown in FIG. 18, after the first pass through the continuous reactor at 18 GPM under three chemical dosage conditions, the treated effluent was collected, and additional reagents were added under varying chemical conditions, designated as Addition 1, Addition 2, and Addition 3 and shown in Table 5, below. The mixed solution was then treated again at 18 GPM using the continuous reactor. In this way, the reactor was used to simulate a treatment process using a series of two reactors with a second treatment between the two reactors.

TABLE 5
First pass reagent dosing conditions and
second pass reagent dosing additions.

| | First pass | | | | | Second pass | | |
|---|---|---|---|---|---|---|---|---|
| Conditions | Na₂SO₃ | | KI | | Additions | Na₂SO₃ | | KI |
| Condition B | 1 | mM | 2 | mM | Addition 3 | 2 | mM | 0 |
| Condition C | 1 | mM | 1 | mM | Addition 2 | 1 | mM | 0 |
| Condition D | 0.5 | mM | 0.5 | mM | Addition 1 | 0.5 | mM | 0 |

PFBA levels were tested in the influent and effluent streams at each condition and at various time points, and the results are shown in FIG. 19 and Table 6, below. In FIG. 19, the influent and effluent PFBA concentration is plotted against time (minutes). The PFBA concentration is shown in ppb in the gray series corresponding to the right axis. The effluent PFBA concentration is shown in ppt in the black series corresponding to the left axis. The 1st pass reagent dosing conditions are labelled as Condition D, C, and B, and the 2nd pass chemical additions are labeled as Addition 1, 2, and 3. Notably, the effluent from the first pass becomes the influent for the secondary addition pass, resulting in the fluctuations observed in the influent stream.

As shown in FIGS. 18 and 19 and Table 6, with an influent PFBA of 72.8-118.0 ppb, the effluent PFBA concentrations after the first pass averaged approximately 4 ppb under optimal reaction conditions B and C, demonstrating a PFBA destruction percentage of 95-97% after the first pass at 18 GPM. The effluent PFBA concentration was further reduced to approximately 100 ppt after the second pass under selected reaction conditions (e.g., Condition B+Addition 3 and Condition C+Addition 2). 99.9% PFBA destruction was achieved by the complete sequential destruction process at 18 GPM.

TABLE 6
Average PFBA concentrations (ppb) in the influent
stream and the effluent streams at each condition.

| | PFAS | | PFBA (ppb) |
|---|---|---|---|
| Influent | | | 72.8-118.0 |
| | Effluent | Condition B | 3.96 ± 0.63 |
| | | Condition B + Addition 3 | 0.11 ± 0.09 |
| | | Condition C | 4.20 ± 0.74 |
| | | Condition C + Addition 2 | 0.11 ± 0.05 |
| | | Condition D | 21.19 ± 15.88 |
| | | Condition D + Addition 1 | 0.81 ± 0.34 |

### Example 6

A kinetic mathematical reactor model has been constructed to determine the rate of PFAS destruction in a multi-lamp photo reactor. The critical inputs to the model are the reactor and lamp geometry, lamp power, efficiency and wavelength, chemical concentration of photosensitizer system reagents (in this case iodide and sulfite), pH, and the known second order rate constants for the reduction of PFAS compounds (adjusted to the reactor temperature in accordance with their Arrhenius dependent behavior), as well as the known second order rate constant for the reduction of iodine radical by sulfite.

For the data set generated in these examples, the model input 25 micro-molar molecular oxygen into each PFAS solution modeled. It then accounts for the reaction between oxygen and sulfite, in which these react to yield sulfate, such that 2SO₃²⁻+O₂ forms 2SO₄²⁻. The sulfite concentrations entered in the model are always greater than 2 times the dissolved oxygen concentration; thus, in all of the modeled runs the dissolved oxygen concentration is set to zero and the sulfite concentration is stoichiometrically reduced by the amount of dissolved oxygen initially present. This is the concentration of sulfite plotted, with all of the plots standing without alteration such that there is zero oxygen and a broad range of sulfite concentration with the minimum 0.001 mM.

In this example, the kinetic reactor model was used to test a solution of PFAS comprising 400 ppb Perfluorobutanoic acid (PFBA), 20 ppb 7H-Perfluoroheptanoic Acid, and 2000 ppb Trifluoroacetic acid (TFA). Concentration dependence of the destruction was done by multiplying the concentration of this solution, C, by a scaling factor. For example, when a scaling factor of 0.1 is applied, i.e., 0.1×C, the solution comprised 40 ppb PFBA, 2 ppb 7H-Perfluoroheptanoic Acid, and 200 ppb TFA.

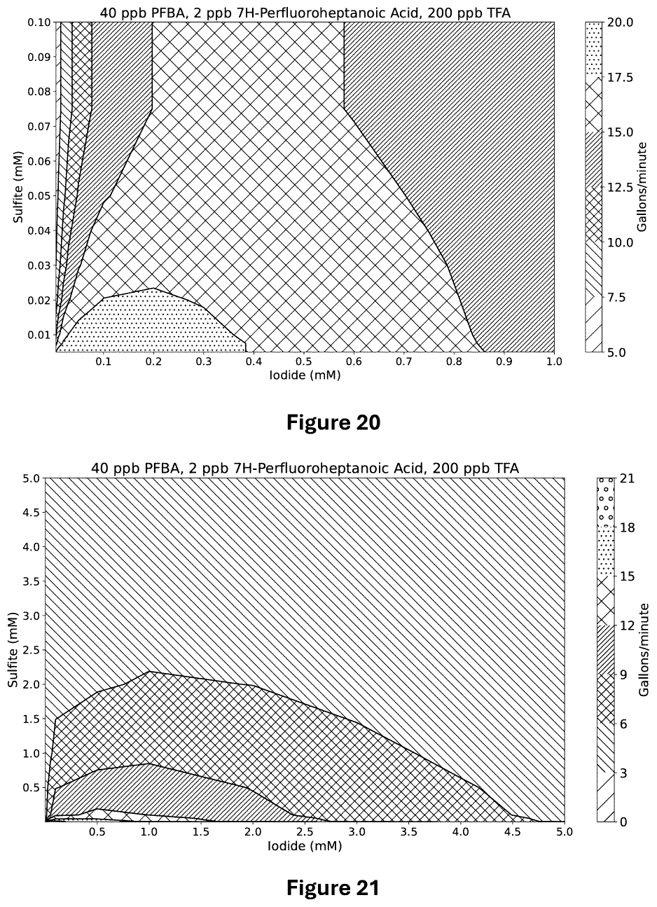

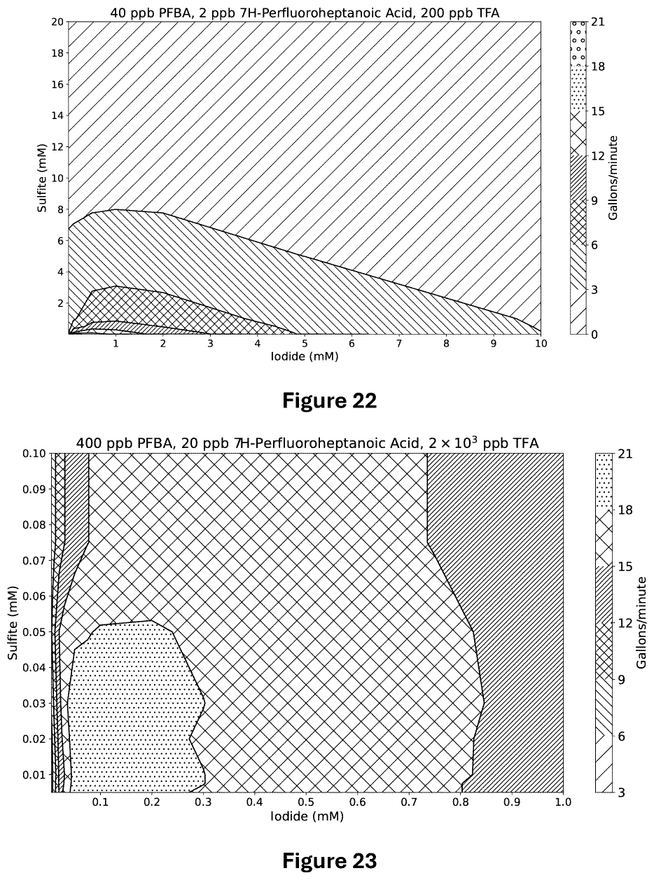

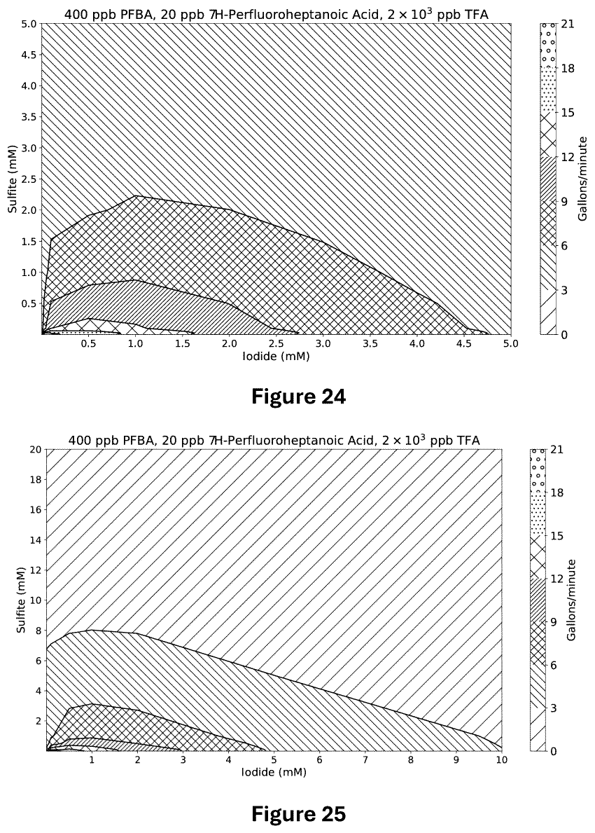

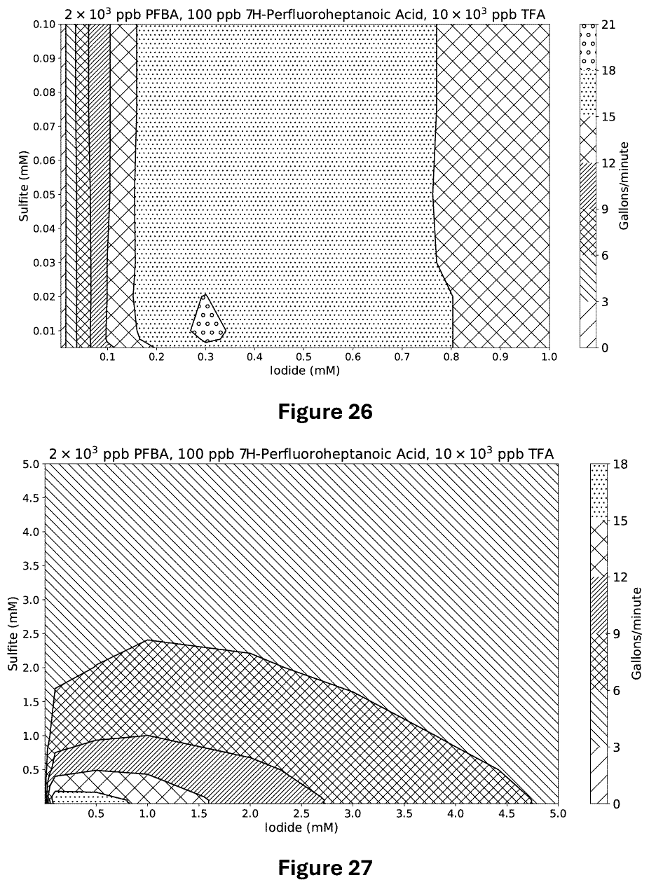

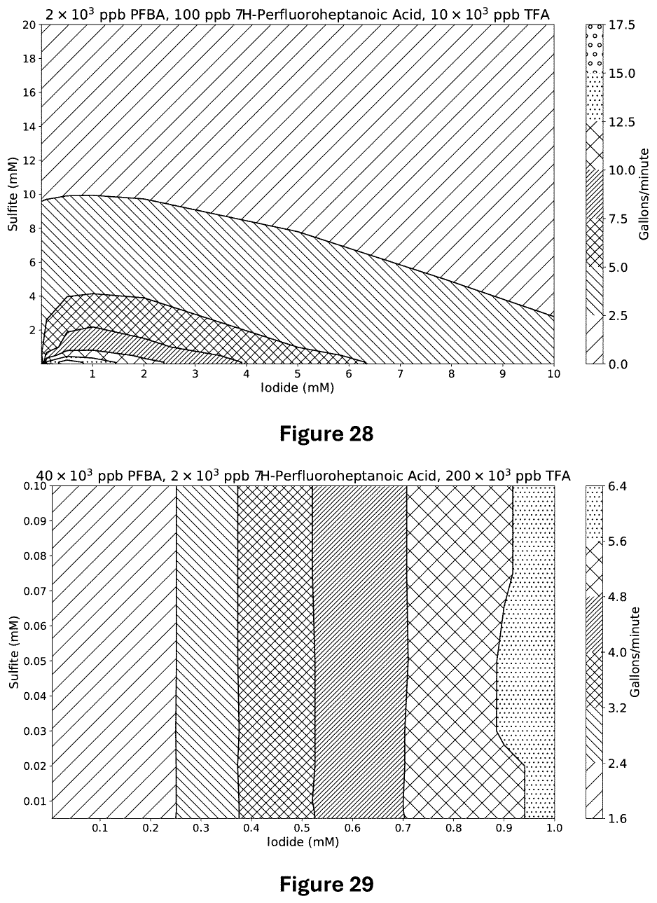

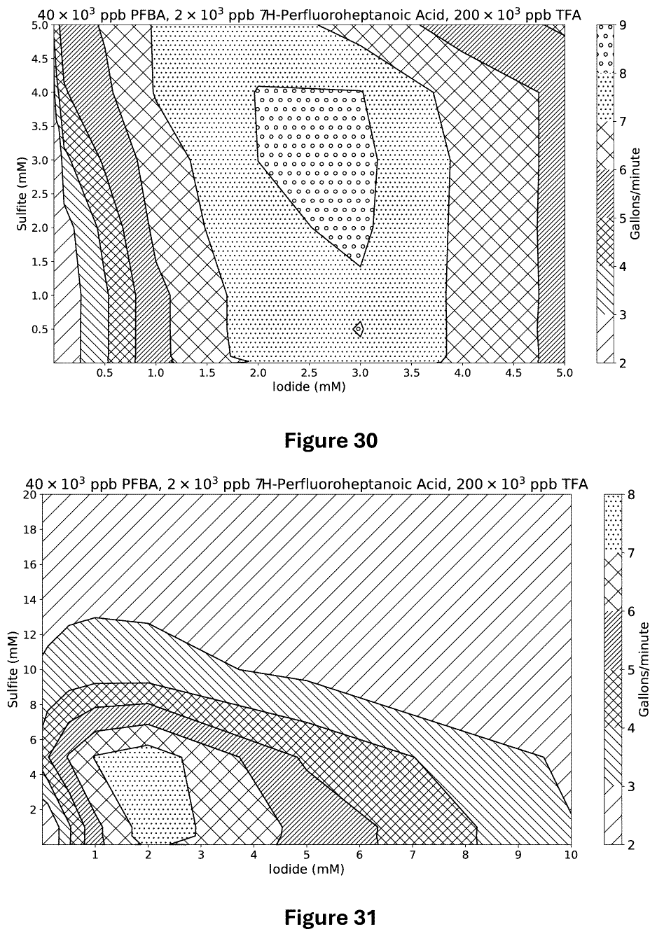

The kinetic reactor model was run using a matrix of sulfite and iodide concentrations at pH=12. The wavelength of the lamps in the reactor is 254 nm. Iodide ranged between 0.001 mM and 10 mM, and sulfite between 0.001 mM and 20 mM. The percent destruction of the parent PFAS compounds, i.e. the concentration weighted average of the destruction curves for each individual component, determined as a function of time, was recorded per each combination of sulfite and iodide. The reactor residence time required to destroy 99.99 percent (4 Log destruction) of the parent compounds was determined from the recorded data. This time (in minutes) was divided by the reactor liquid volume (in gallons) and the results are shown as contour plots for each scaled concentration (C) in FIGS. 20-31). FIGS. 20-22 detail PFAS destruction 0.1× C using an ever broadening range of photosensitizer system reagents per each concentration of PFAS solution. FIGS. 23-25, 26-28, and 29-31 show the same plots at 1×C, 5×C and 100×C, respectively. The kinetic model calculations determine the residence time considering only a static, non-flowing reactor. However, comparison of experiments to the kinetic reactor model demonstrates that the predicted residence times divided by the reactor capacity correlate very well with the maximum flow rate allowable to achieve a given percentage of destruction. Although 99.99 percent PFAS destruction was used in the model, other levels of PFAS destruction may be achieved such as about 80% or more, or about 90% or more, or about 95% or more, or about 99% or more, for example.

A description of the optimized photosensitizer system dose regime is provided in the caption of each figure. The plots demonstrate destruction in gallons per minute, gpm, (z-axis out of the plane of the paper, indicated by hatched areas) of PFAS solution as a function of sulfite concentration (y-axis), iodide concentration (x-axis).

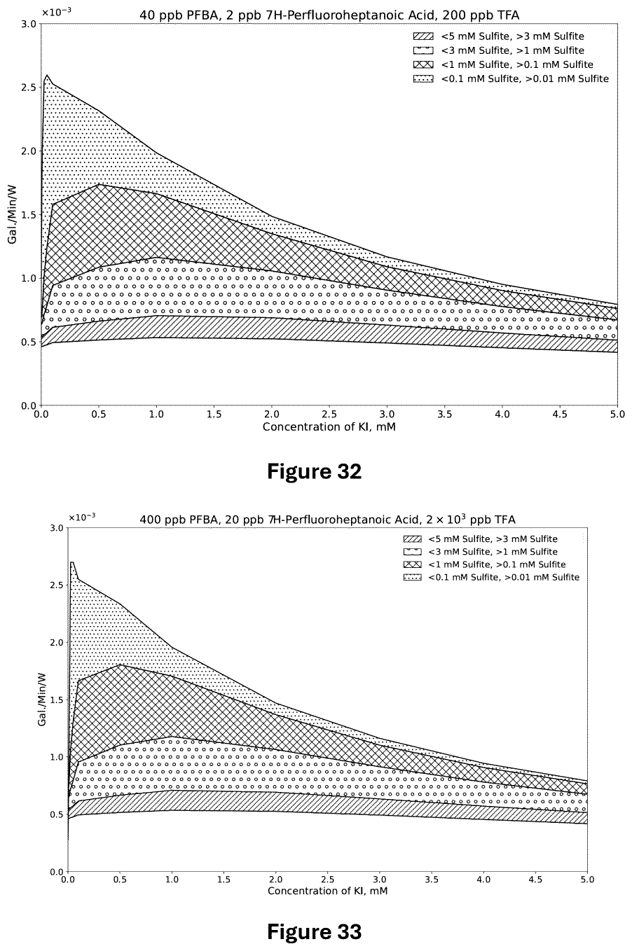

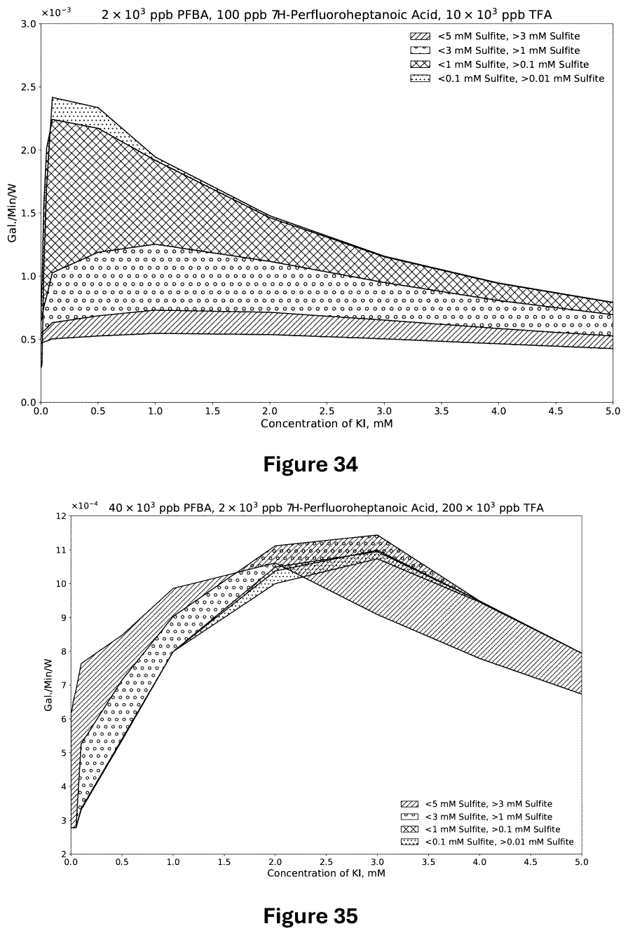

FIGS. 32-35 show destruction efficiency as a function of a range of sulfite concentrations for each of the PFAS mixtures shown in FIGS. 20-31 (0.1×C-100×C). The destruction is characterized by the power input per unit volume of PFAS solution per unit time, in this case gallons/min/Watt. These results show that for solutions below 2.5 ppm the destruction efficiency is much the same. However, at around 12.5 ppm, the destruction efficiency begins to taper off and falls below 2.5×10³ gal/min/Watt. Larger sulfite doses at this concentration provide the same efficiency as do smaller doses of sulfite for PFAS concentrations below 12.5 ppm for an equivalent dose of iodide (See FIGS. 32-34, cross-hatched region). In the range 250 ppm PFAS, the peak destruction efficiency is less than 10 times that for lower concentrations of PFAS (FIG. 34). Although in this case the total amount of PFAS destroyed is ~100 times that of the ~12.5 ppm solution (FIG. 34), destruction at the 4 log level yields a final PFAS concentration of 25 ppb, still three orders of magnitude above a desired destruction level of 50 ppt.

### Example 7

In this example, the addition of bromide, particularly between 20 mM and 40 mM, to a UV/Sulfite (1 mM) system irradiated at 222 nm, was shown to improve the rate of defluorination of a laboratory-produced 5 ppm PFOA sample.

The laboratory PFOA sample was balanced to a pH of 12 with 20 mM NaOH before dispensing into 100 mL quartz vials (QP062, Aireka Scientific Co., Ltd, HK). The sample vials were then prepared with the following reaction conditions, in triplicate: 1 mM Na₂SO₃, 1 mM Na₂SO₃ and 1 mM KBr, 1 mM Na₂SO₃ and 20 mM KBr, 1 mM Na₂SO₃ and 40 mM KBr, 1 mM Na₂SO₃ and 100 mM KBr, and 1 mM Na₂SO₃ and 200 mM KBr. The prepared samples were then placed between two 150 W 222 nm krypton-chloride excimer lamps for 30 minutes of irradiation. 5 mL samples were taken via syringe at 1, 3, 5, 7, 10, 15, and 30 minutes. 1 mL of these were kept aside for LC-MS analysis, with the remaining 4 mL used to measure the free fluoride released by the destruction of PFOA. Defluorination analysis was performed with a Fluoride Ion Selective Electrode (9809BNWP, ThermoFisher Scientific). LC-MS analysis was performed using a triple quadrupole mass spectrometer (LCMS-8060, Shimadzu Corporation, USA). The PFAS concentrations were measured using the EPA 1633 method.

For the LC-MS analysis in this example, as well as Examples 8 and 9 below, 6 samples of the untreated PFOA stock solution were used as timepoint 0 samples over the multi-day course of the experiments. This was done to minimize the number of LC-MS samples to be analyzed. On average, these timepoint 0 PFOA samples were calculated to be about 7 ppm in concentration. The data showing less than 0% destruction is a result of the early timepoint of a specific condition (e.g. 1 mM sulfite 40 mM bromide) having an observed PFOA concentration greater than the average of the timepoint 0 samples (e.g. 7.8 ppm). The time offset is similarly due to this approach to the timepoint 0 samples, with each of the conditions being “tracked” from one minute of irradiation onwards and the starting point determined by the average of the aforementioned 6 start-point samples (i.e. Not “tracked” with individual conditions.)

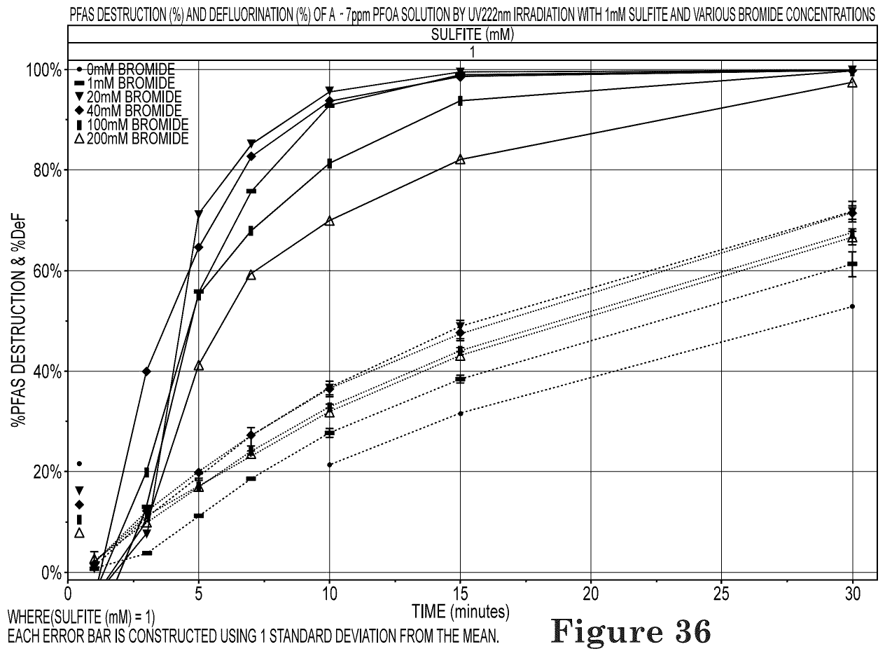

The results are shown in FIG. 36, which presents a graph of destruction (LC-MS analysis) and defluorination (analysis of free fluoride) of PFOA (5 ppm) by a UV222 nm in a sulfite-bromide photoreduction system. Sulfite (Na₂SO₃) concentration of 1 mM were paired with 0, 1, 20, 40, 100, and 200 mM bromide (KBr) as described above. As seen in FIG. 36, the presence of bromide in all conditions improved the defluorination of PFOA. The control with 1 mM sulfite in absence of bromide achieved roughly 50% defluorination while the addition of 1 mM bromide improved this to about 61%. Of all conditions tested in combination with 1 mM sulfite, 20 mM and 40 mM of bromide were the most effective, achieving approximately 71% defluorination of PFOA. Concentrations of bromide at or greater than 100 mM were found to have a negative effect on defluorination, with performance decreasing to roughly 65%.

### Example 8

In this example, the addition of bromide, particularly between 20 mM and 40 mM, to a UV/sulfite (4 mM) system irradiated at 222 nm, was shown to improve the rate of defluorination of a laboratory-produced 5 ppm PFOA sample.

The laboratory PFOA sample was balanced to a pH of 12 with 20 mM NaOH before dispensing into 100 mL quartz vials (QP062, Aireka Scientific Co., Ltd, HK). The sample vials were then prepared with the following reaction conditions, in triplicate: 4 mM Na₂SO₃ and 1 mM KBr, 4 mM Na₂SO₃ and 20 mM KBr, 4 mM Na₂SO₃ and 40 mM KBr, 4 mM Na₂SO₃ and 100 mM KBr, and 4 mM Na₂SO₃ and 200 mM KBr. The prepared samples were then placed between two 150 W 222 nm krypton-chloride excimer lamps for 30 minutes of irradiation. 5 mL samples were taken via syringe at 1, 3, 5, 7, 10, 15, and 30 minutes. 1 mL of these were kept aside for LC-MS analysis, with the remaining 4 mL used to measure the free fluoride released by the destruction of PFOA. Defluorination analysis was performed with a Fluoride Ion Selective Electrode (9809BNWP, ThermoFisher Scientific). LC-MS analysis was performed using a triple quadrupole mass spectrometer (LCMS-8060, Shimadzu Corporation, USA). The PFAS concentrations were measured using the EPA 1633 method.

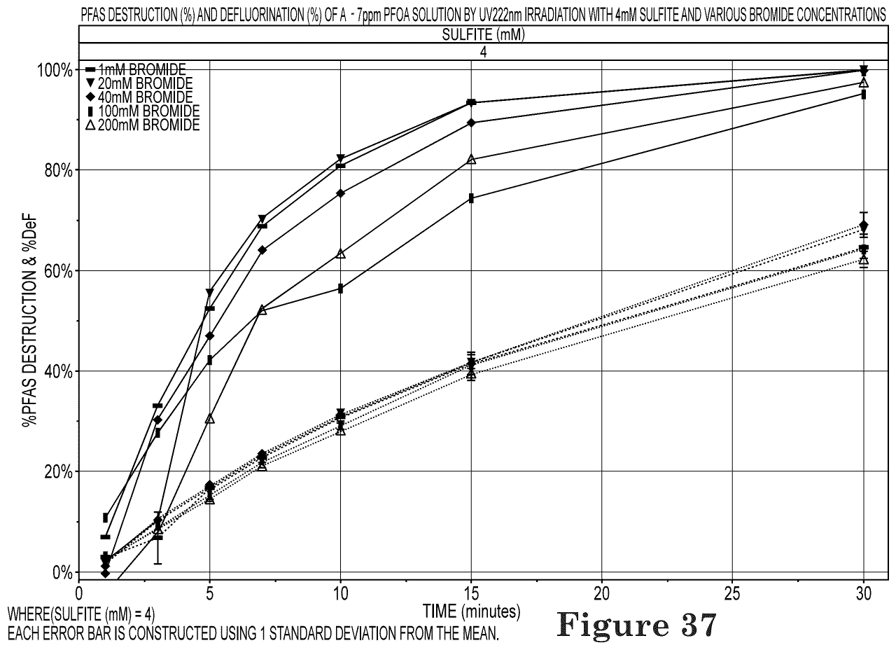

The results are shown in FIG. 37. FIG. 37 shows a graph of destruction (LC-MS analysis) and defluorination (analysis of free fluoride) of PFOA (5 ppm) by a UV222 nm in the sulfite-bromide photoreduction system. Sulfite (Na₂SO₃) concentration of 4 mM was paired with 1, 20, 40, 100, and 200 mM bromide (KBr) as described above. As shown in FIG. 37, 20 and 40 mM bromide were the most effective pairing with 4 mM sulfite in the UV222 nm system, achieving approximately 68% defluorination of 5 ppm PFOA at 30 minutes. The 1 mM bromide condition was marginally worse at 65%, whereas the defluorination with concentrations of 100 mM or greater was progressively diminished (e.g. 62% with 200 mM).

### Example 9

In this example, the addition of bromide, particularly between 20 mM and 40 mM, to a UV/Sulfite (10 mM) system irradiated at 222 nm was shown to improve the rate of defluorination of a laboratory-produced 5 ppm PFOA sample.

The laboratory PFOA sample was balanced to a pH of 12 with 20 mM NaOH before dispensing into 100 mL quartz vials (QP062, Aireka Scientific Co., Ltd, HK). The sample vials were then prepared with the following reaction conditions, in triplicate: 10 mM Na₂SO₃ and 1 mM KBr, 10 mM Na₂SO₃ and 20 mM KBr, 10 mM Na₂SO₃ and 40 mM KBr, 10 mM Na₂SO₃ and 100 mM KBr, and 10 mM Na₂SO₃ and 200 mM KBr. The prepared samples were then placed between two 150 W 222 nm krypton-chloride excimer lamps for 30 minutes of irradiation. 5 mL samples were taken via syringe at 1, 3, 5, 7, 10, 15, and 30 minutes. 1 mL of these were kept aside for LC-MS analysis, with the remaining 4 mL used to measure the free fluoride released by the destruction of PFOA. Defluorination analysis was performed with a Fluoride Ion Selective Electrode (9809BNWP, ThermoFisher Scientific). LC-MS analysis was performed using a triple quadrupole mass spectrometer (LCMS-8060, Shimadzu Corporation, USA). The PFAS concentrations were measured using the EPA 1633 method.

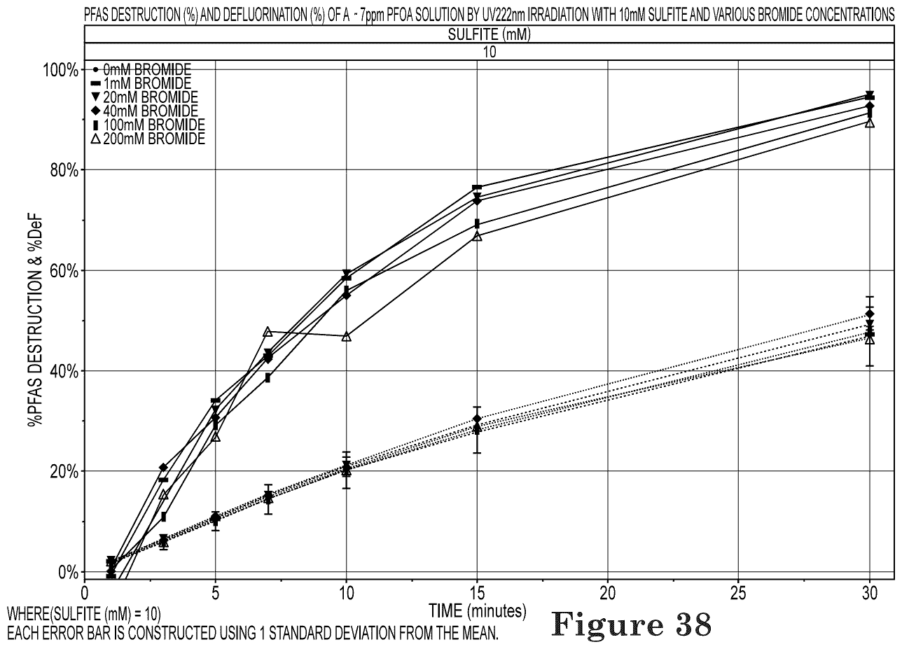

The results are shown in FIG. 38. FIG. 38 shows a graph of destruction (LC-MS analysis) and defluorination (analysis of free fluoride) of PFOA (5 ppm) by a UV222 nm sulfite-bromide photoreduction system. Sulfite (Na₂SO₃) concentration of 10 mM was paired with 1, 20, 40, 100, and 200 mM bromide (KBr) as described above. As shown in FIG. 38, when used with 10 mM Na₂SO₃, the UV222 nm Sulfite/Bromide system demonstrated the greatest defluorination with 40 mM bromide at 30 minutes (approximately 51%). 20 mM bromide 10 mM Na₂SO₃ performed marginally worse with approximately 49% defluorination. Notably the 10 mM Na₂SO₃ condition without bromide demonstrated comparable performance to those samples with 1 mM, 100 mM, and 200 mM bromide approximately 47% defluorination). The tight grouping in performance of all tested bromide conditions paired with 10 mM Na₂SO₃ suggests that, at such elevated concentrations, sulfite is the dominant influence in the defluorination of PFOA.

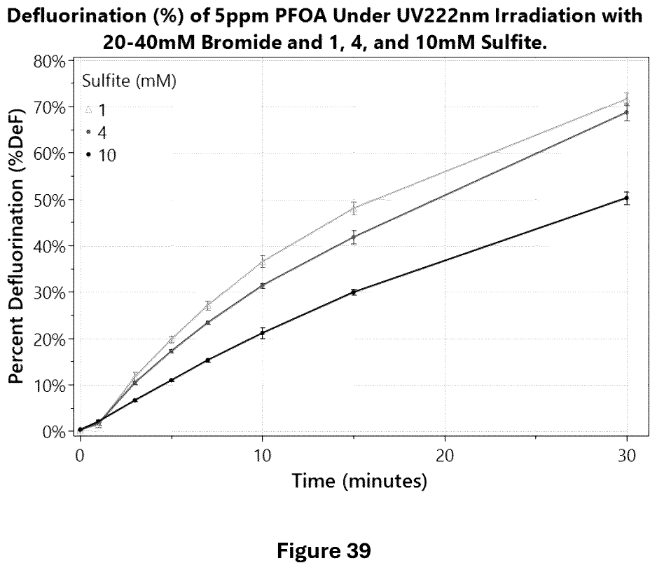

FIG. 39 shows the results of defluorination of PFOA (5 ppm) by the UV222 nm/Sulfite-Bromide photoreduction system for the 20 and 40 mM bromide concentrations at 1, 4, and 10 mM Na₂SO₃ from Examples 7-9. Increasing concentration of sulfite seen to progressively diminish PFOA defluorination. Indeed, as seen in FIG. 39, the optimal 20 to 40 mM bromide conditions' defluorination performance was progressively degraded with increasing Na₂SO₃ concentrations. Whereas 1 mM Na₂SO₃ 20-40 mM Bromide in Example 7 achieved an average defluorination of approximately 72%, increasing Na₂SO₃ concentration to 10 mM as in Example 9 reduced defluorination of the PFOA to only approximately 50%.

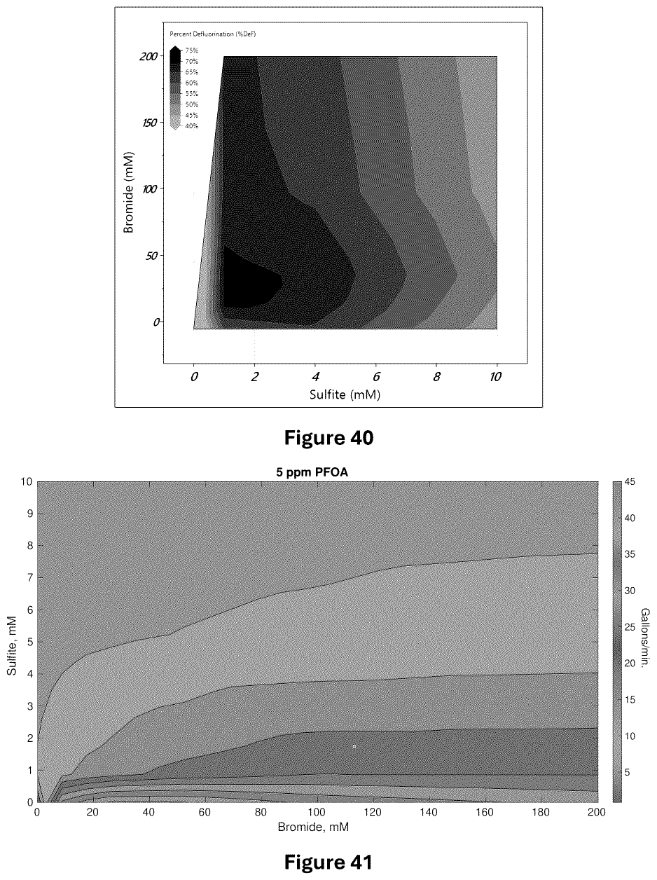

FIG. 40 presents a contour plot of the defluorination results from Examples 7-9. In FIG. 40, the contour plot shows defluorination of PFOA (5 ppm) by a UV222 nm/Sulfite-Bromide photoreduction system. Bromide concentration (mM) is on Y-axis and Na₂SO₃ concentration (mM) is on X-axis. The shaded areas represent the increasing extent of defluorination by 30 minutes of 222 nm irradiation. 1 mM sulfite paired with 20-40 mM bromide is shown to be the most effective condition among those tested, reaching approximately 75% defluorination. This demonstrates that UV222 nm irradiation of 1 mM sulfite and 20-40 mM bromide is shown to be the most effective condition among those tested, achieving the greatest extent of PFOA defluorination; approximately 72% by 30 minutes.

### Example 10

A kinetic mathematical reactor model was constructed to predict PFAS destruction over a range of conditions. The model determines the rate of destruction of individual components of PFAS in solution, in multi-lamp or single lamp photoreactors geometries. The critical inputs to the model are the reactor and lamp geometry, lamp power, efficiency and wavelength, chemical concentration of sensitizers (in this example, bromide and sulfite), pH, and the known second order rate constants for the reduction of PFAS compounds (adjusted to the reactor temperature in accordance with their Arrhenius dependent behavior), as well as the known second order rate constant for the reduction of bromide radical by sulfite.

A solution of PFAS comprising 5 ppm Perfluooctanoic Acid (PFOA) was tested in the kinetic reactor model. The kinetic reactor model was run using a matrix of sulfite and bromide concentrations at pH=12. The wavelength of the lamps in the reactor is 222 nm. The bromide concentration ranged between 0.001 mM to 2000 mM, and sulfite between 0.001 mM and 10 mM. The reactor residence time required to destroy 99.99 percent (4 Log destruction) of the parent compounds was determined from the modeled data. This residence time (in minutes) was divided into the reactor liquid volume (in gallons) and the results are shown in FIG. 41. The kinetic model calculations determine the residence time considering only a static, non-flowing reactor. However, comparison of experiments to the kinetic reactor model has demonstrated that the predicted residence times divided into the reactor capacity correlate very well with the maximum flow rate allowed to achieve a given percentage of destruction in an experiment.

The plots shown in FIG. 41 demonstrate destruction in gallons per minute, gpm, (z-axis out of the plane of the paper, indicated by colored zones) of the 5 ppm PFOA solution as a function of sulfite concentration (y-axis) and bromide concentration (x-axis). The model output shown for this Example is for PFOA in a 48 lamp multi-bulb immersion reactor whereas the experimental data shown in Examples 7-9 was measured in a double lamp reactor in which the PFOA solution was contained in a quartz vial and placed between the lamps. Thus, the calculated output is much greater than the experimental data, yet expected to scale proportionally.

### Example 11

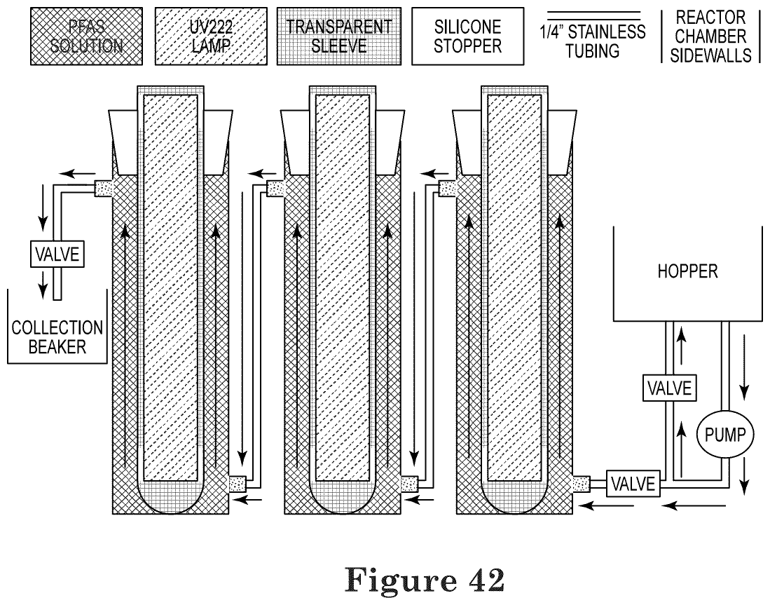

A continuous flow serial reactor with UV illumination at 222 nm was constructed to test the destruction of PFAS. A schematic diagram of this reactor is shown in FIG. 42. This diagram is not to scale. The thin black arrows indicate the direction of the flow of the solution through the tri-reactor. The parts of the system are labeled in the key above the diagram, and lamps to wires are not included. This reactor is comprised of three identical cylindrical reaction chambers, each connected in series with stainless steel tubing. Ultraviolet lamps, surrounded by sealed transparent quartz tubes, are immersed into cylindrical chambers along the center axis of the reactor chambers. The reaction solution containing PFAS and photosensitizers is flowed through the space between the immersion tube and the wall of the reactor chambers at a constant rate. Hereafter, this reactor system will be referred to as the tri-reactor and is a small-scale representation of three full size reactors in series. The concentration of the parent PFAS compound in the influent and effluent was measured using a quadrupole-LCMS system to determine the percentage of parent compound destruction. Total defluorination was measured in the effluent by ion-selective electrode.

Each reactor chamber is a 304 stainless steel cylinder with 3.2 mm thick side walls and inner diameter (I.D) of 71 mm. All three reaction chambers stand vertically with respect to the laboratory bench top and are 444.5 mm in length. The reaction chambers are sealed on the bottom end with a welded 304 stainless steel plate. The axially symmetric sleeves are comprised of UV transparent quartz (GE 214, Technical Glass Products, Inc., Painesville Twp. Ohio), 55 mm OD, 52 mm ID, and 500 mm in length. The sleeves are tapered and sealed on the ends that are immersed in the reactor chambers. These sleeves are friction fitted through a 55 mm hole cut through a tapered silicone stopper (diameter at half height, 71 mm) so that there is approximately 2 cm of the sleeve exposed above the top of the stopper on the top end. The sleeve with the affixed stopper fits into the stainless reaction chamber with the sealed end of the sleeve toward the bottom. The stopper slides downward along the long axis of the sleeve and fits tight against the exterior with the rim of the stainless chamber and the interior with the quartz sleeve. A 90 mm diameter, 3.2 mm thick stainless-steel plate with a 60 mm centered hole is placed over the top of the reactor chamber. This plate is forced against the stopper to exert constant pressure so that the silicone stopper seals against the reactor rim and allows the reactor chamber to operate under pressure. Each reactor chamber holds 750 ml of solution, for a 2.25 L capacity for the tri-reactor assembly.

A cylindrical UV222 nm lamp (First UV Global, China) is placed into each of the three cylindrical sleeves in the tri-reactor through the top opening of the sleeve. The largest outer diameter (O.D.) of the lamp is 51 mm. The lamps are 450 mm in length. The lamps are connected to the sealed power supplies through co-axial cables and bulkhead connectors. The lamps are powered by ballast system that supplies 100 Watts of electrical power at 20 KV to each lamp for a total of 300 W for the full tri-reactor system. The irradiance of each lamp was measured with a UV radiometer, and the output of each lamp determined to be 2.5 watts. Thus, the full tri-reactor system outputs approximately 7.5 watts of photon intensity with electrical-to-photon conversion efficiency of about 2.5%.

Each reaction chamber of the tri-reactor is placed in a line with about 150 mm separating their centers, and each is secured with a clamp to a vertical rod affixed to the laboratory bench. The reactors are connected from bottom to top with 6.4 mm O.D. 304 stainless steel tube. Reactor influent flows from a 4 Liter stainless steel hopper through a pumping loop comprised of 6.4 mm I.D. stainless steel tubing, a small impeller pump (Bayite BYT-7A014 DC 12V Solar Hot Water Heater Circulation Pump Low Noise 3M Discharge Head 2.1GPM), a flow valve, and a shunt valve allowing return flow to the 4 L hopper. The system allows the pump to be operated at a constant rate, yet the pumping rate into the tri-reactor can be variable. Influent enters the bottom of the first reaction chamber and flows upward to fill the reaction chamber, see FIG. 42. Solution flows from the top of the first reaction chamber through a 6.4 mm I.D. stainless steel tube into the bottom of the second reaction chamber, wherein it flows upward, filling the chamber, and then out through a 6.4 mm I.D. stainless line into the bottom of the third reactor of the tri-reactor. Solution then flows upward through the third reactor, filling it. It flows under pressure through a valve located on the side of the third reaction chamber 5 cm from the top and flows into a collection beaker. Reactor effluent is collected from the flow into this beaker.

For each experiment, the 4-liter hopper is fully emptied from the previous experiment, and each of the three reaction chambers is drained through low point valves located in each of the chambers, see FIG. 42. A fresh PFAS-containing solution is poured into the 4-liter hopper, the lamps turned on, and the solution flowed into the reactor system at about 50 mL/minute. Upon initial observation of effluent entering the collection beaker, a timer is started. During the first 500 ml of influent collection, the flow rate is tuned to 50 mL/minute. After about 3 L of solution is flowed through the tri-reactor at this rate, effluent collection begins. Additional samples are collected at 200-250 mL intervals; these are tested for free-fluoride and parent compound destruction.

The influent solution contains about 23.4 micromolar (5 ppm by weight) perfluorobutanoic acid (PFBA, Aldrich) at pH 11 (adjusted by adding 2 millimolar NaOH, Aldrich). Sodium Sulfite (reagent grade, Cessec, USA) and Potassium iodide (reagent grade, Deepwater Chemicals, Inc) and potassium bromide (Aldrich) were added in amounts indicated in the tables given for each of the three examples. The solution was flowed through the reactor at 50 ml/minute in all experiments.

For this example, the influent pH was 11 and the reagent levels were adjusted to correspond to 99% optical absorption in the reactor. The results of these experiments are presented in rows 1a-1e of Table 7. For samples 1b and 1d in Table 7, % defluorination measurements were not taken. Iodide is added in amounts between 0 and 100 micromolar to a solution containing an amount of sulfite necessary to maintain a consistent absorbance of 99% of the UV222 photons within the fluid. Sulfite was added at a concentration shown in Table 7, 0.5 mM of this sulfite was lost to removing oxygen. Calculations indicate it will take this amount of sulfite to remove 8 ppm oxygen expected to be present in the reaction solution at room temperature. Destruction of the parent PFBA is 99.98% with 0 iodide and 1.3 mM sulfite (Sample 1a). Destruction is 99.99% and 99.98% with 10 and 50 micromolar iodide, respectively (Samples 1b and 1c). These results are statistically indistinguishable. When 100 micromolar iodide is used in conjunction with 0.82 mM sulfite, destruction decreases to 99.89% (row 1d). With no sulfite and 162 micromolar iodide, parent PFBA compound destruction is less than 10% (row 1e). These results show that sulfite and iodide are effective sensitizers for UV-based PFAS destruction using 222 nm illumination, and that iodide can be added in significantly lower quantities than sulfite to maintain high levels of PFAS destruction.

TABLE 7
% PFBA Destruction at pH 11 with Iodide as the Halide and Reagents
Adjusted to Correspond to 99% Absorption in the Reactor

| | Halide: Iodide | Sulfite | % PFBA | |
|---|---|---|---|---|
| Sample | (micromolar) | (mM) | Destruction | % Defluorination |
| 1a | 0 | 1.8 | 99.98 | 72 |
| 1b | 10 | 1.6 | 99.99 | — |
| 1c | 50 | 1.25 | 99.98 | 57.8 |
| 1d | 100 | 0.82 | 99.87 | — |
| 1e | 162 | 0 | 5.00 | 4.3 |

For the second set of samples a solution of 7 millimolar bromide and 1.25 mM sulfite was used as the sensitizer system. Sulfite was added at the concentration shown in Table 8, 0.5 mM of this sulfite was lost to removing oxygen. Calculations indicate it will take this amount of sulfite to remove 8 ppm oxygen expected to be present in the reaction solution at room temperature. PFBA destruction was 99.97% at a flow rate of 50 ml/min (Sample 1f, Table 8). Without any added sulfite, parent compound destruction for 21 mM bromide was less than 7% (Sample 1g). These results show bromide may also be used as the halide sensitizer in combination with sulfite for UV-based PFAS destruction using 222 nm illumination, but bromide alone is not effective.

TABLE 8
% PFBA Destruction at pH 11 with Iodide as the Halide and Reagents
Adjusted to Correspond to 99% Absorption in the Reactor

| | Halide: | | | |
|---|---|---|---|---|
| | Bromide | Sulfite | % PFBA | |
| Sample | (Millimolar) | (mM) | Destruction | % Defluorination |
| 1f | 7 | 1.25 | 99.97 | 73.4 |
| 1g | 21 | 0 | 6.18 | 1.6 |

### Example 12

This example uses the same tri-reactor process discussed in Example 11 but evaluates different sensitizer systems. Solutions were prepared with a constant sulfite concentration of 0.75 mM sulfite and a variable concentration of iodide. Sulfite was added at a concentration shown in Table 9, 0.5 mM of this sulfite was lost to remove oxygen. Calculations indicate it will take this amount of sulfite to remove 8 ppm oxygen expected to be present in the reaction solution at room temperature. With no added iodide, destruction of the parent compound is 97% (Sample 2a). Addition of 2, 10 and 50 or 100 micromolar iodide significantly increases defluorination and destruction (Samples 2b-2e).

TABLE 9
% PFBA Destruction with constant sulfite levels and
different iodide levels added as the sensitizer.

| | Halide: Iodide | Sulfite | % PFBA | |
|---|---|---|---|---|
| Sample | (micromolar) | (mM) | Destruction | % Defluorination |
| 2a | 0 | 1.25 | 97.00 | 47.3 |
| 2b | 2 | 1.25 | 99.82 | 61.4 |
| 2c | 10 | 1.25 | 99.90 | — |
| 2d | 50 | 1.25 | 99.97 | 57.8 |
| 2e | 100 | 1.25 | 99.98 | — |

### Example 13

This example uses the same tri-reactor process discussed in Example 11. In this example solutions were prepared with a constant sulfite concentration of 1.25 mM and a variable concentration of bromide. Sulfite was added at a concentration shown in Table 10, 0.5 mM of this sulfite was lost to removing oxygen. Calculation indicates it will take this amount of sulfite to remove 8 ppm oxygen expected to be present in the reaction solution at room temperature. For samples 2g and 2i in Table 10, % defluorination measurements were not taken. With no added bromide, destruction of the parent compound is 97% (Sample 2f). Addition of 1.4, 7, and 21 millimolar bromide significantly increases defluorination and destruction (Samples 2f-2i). The addition of 1.4 and 7 mM bromide increases the PFBA destruction to 99%, reducing 3% PFBA remaining to 0.03% PFBA remaining. This shows PFAS destruction is significantly enhanced by the addition of bromide, even at levels as low as 1.4 millimolar.

TABLE 10
% PFBA Destruction with constant sulfite levels and
different bromide levels added as the sensitizer.

| | Halide: Bromide | | % PFBA | |
|---|---|---|---|---|
| Sample | (Millimolar) | Sulfite | Destruction | % Defluorination |
| 2f | 0 | 1.25 | 97.00 | 47.3 |
| 2g | 1.4 | 1.25 | 99.97 | — |
| 2h | 7 | 1.25 | 99.97 | 73.4 |
| 2i | 21 | 1.25 | 99.36 | — |

### Example 14

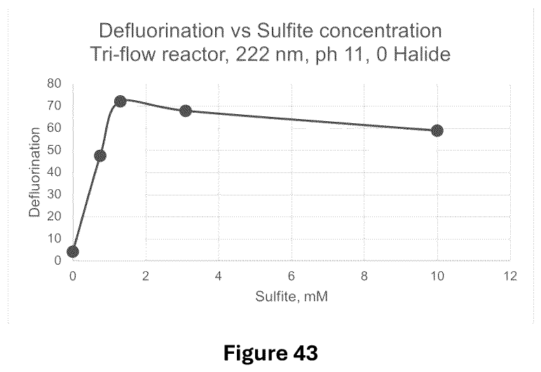

This example uses the same tri-reactor process discussed in Example 11 but evaluates sulfite sensitizer systems with no added halide. Solutions were prepared and run through the tri-reactor with a variable concentration of sulfite ranging from 0 to 10 mM, 0.5 mM of this sulfite was lost to removing oxygen. Calculation indicates it will take this amount of sulfite to remove 8 ppm oxygen expected to be present in the reaction solution at room temperature. Percent PFBA destruction and percent defluorination results can be seen in Table 11. With 0 mM sulfite added, parent PFBA destruction is ~23% and defluorination ~4% at pH 11 and pH7 (Samples 3a-3b). When the concentration of sulfite is increased to 1.25 mM, PFBA destruction increases to 97% and defluorination to 47.3% (Sample 3c). With further increase in the sulfite concentration to 1.8 mM, defluorination increases to a maximum of 72%, and destruction of 99.98% (Sample 3d). A further increase in sulfite concentration to 4.1 mM and 10.5 mM results in reduced defluorination compared to the 1.8 mM solution (Samples 3e and 3f). A plot of defluorination vs. Sulfite concentration is presented in FIG. 43. These results show that sulfite alone can effectively destroy PFAS under UV illumination at 222 nm, but increasing sulfite levels above a threshold corresponding to maximum photon absorption within the full fluid results in diminished defluorination. Table 12 shows a sensitizer solution 1.3 mM Bromide and no added sulfite: Destruction of the parent PFBA compound was 15.8% and defluorination 6.4%.

TABLE 11
% PFBA Destruction with varying sulfite
levels and no additional halide added

| | Halide: | | | De- | |
|---|---|---|---|---|---|
| | Iodide | Sulfite | Destruction | fluorination | Solution |
| Sample | (Micromolar) | (mM) | (%) | (%) | pH |
| 3a | 0 | 0 | 24.0 | 4.1 | pH 11 |
| 3b | 0 | 0 | 22.2 | 3.6 | pH 7 |
| 3c | 0 | 1.25 | 97.0 | 47.3 | pH 11 |
| 3d | 0 | 1.80 | 99.98 | 72.0 | pH 11 |
| 3e | 0 | 4.1 | 99.96 | 67.7 | pH 11 |
| 3f | 0 | 10.5 | 99.93 | 58.7 | pH 11 |

TABLE 12
% PFBA Destruction with no sulfite
and bromide added as the sensitizer

| | Halide: | | | |
|---|---|---|---|---|
| | Bromide | Sulfite | Destruction | Defluorination |
| Sample | (Millimolar) | (mM) | (%) | (%) |
| 3g | 1.3 | 0 | 15.8 | 6.3 |

### Example 15

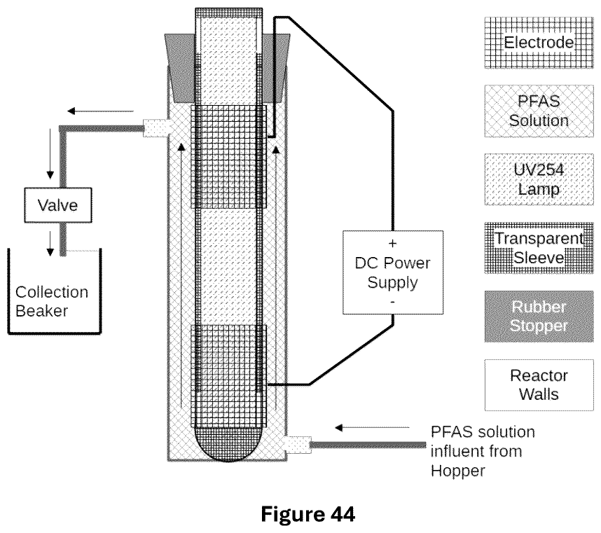

This example shows a continuous flow UV254 reactor with internal electrodes constructed to test the destruction of PFAS and conversion of iodide into an oxidized form. This reactor comprises a cylindrical reaction chamber schematized in FIG. 44. An ultraviolet lamp, surrounded by a sealed transparent quartz tube is immersed in the cylindrical chamber along the center axis of the reactor chamber. Anode and cathode electrodes were affixed to the exterior of the transparent sleeves; the cathode is located near the inlet port and the anode is located near the outlet port. The reaction solution containing PFAS flows through the space between the immersion tube and the wall of the reactor chambers at a constant rate. The concentration of the parent PFAS compound in the influent and effluent was measured using a quadrupole-LCMS system to determine the percentage of parent compound (PFBA) destruction and total defluorination measured in the effluent by ion-selective electrode.

The reactor chamber is constructed from a 304 stainless steel cylinder with 3.2 mm thick side walls and interior diameter (I.D) of 71 mm. The chamber stands vertically with respect to the laboratory bench top and is 444.5 mm in length. The reaction chamber is sealed on the bottom end with a welded 304 stainless steel plate. The axially symmetric sleeve is comprised of UV transparent quartz (GE 214, Technical Glass Products, Inc., Painesville Twp. Ohio), 55 mm OD, 52 mm ID, and 500 mm in length. The sleeve is tapered and sealed on the end that is immersed into the reactor chamber. This sleeve is friction fitted tight through a 55 mm hole cut through a tapered silicone stopper (diameter at half height, 71 mm) so that there is approximately 2 cm of the sleeve exposed above the top of the stopper on the top end. The sleeve with affixed stopper fits into the stainless reaction chamber with the sealed end of the sleeve toward the bottom. The stopper slides downward along the axis of the sleeve and fits tight on the exterior with the rim of the stainless chamber and tight on the interior with the quartz sleeve. A 90 mm (diameter), 3.2 mm thick stainless-steel plate with a 60 mm (diameter) centered hole is placed over the reactor chamber. This plate is forced against the stopper with cables to exert constant pressure so that the silicone stopper does not come loose, and the reactor chamber can operate under pressure. The reactor chamber holds 750 mL of solution.

A cylindrical UV254 nm lamp (UVI 60, Hoenle UV UK Ltd St. Albans, England) is placed into the cylindrical sleeve from the top opening. The largest outer diameter of the lamp is 17.5 mm. The lamp is 435 mm in length. The lamp is powered by ballast system that supplies 40 V and 1.5 amps for a total of 60 watts of electrical power to the lamp. The electrical energy to photon energy conversion efficiency as specified by the manufacturer is 25%, implying a total photon power of 15 watts. The lamp is connected to the sealed power supply through a co-axial cable and bulkhead connectors.

The anode and cathode are platinum coated titanium mesh (Heloawei, China) bound tightly to the reactor sleeve with 0.04 mm stainless steel wire. A 60 Volt adjustable power supply was used to apply bias across the electrodes. The anode is connected to the power supply via a silicone sheathed wire that runs from the supply through the silicone stopper and is soldered to the anode. The cathode is in electrical contact with the stainless-steel reactor chamber, which is connected to the negative terminal of the power supply.

The reactor is secured with a clamp to a vertical rod affixed to the laboratory bench. Reactor influent flows from a 4 L stainless steel hopper through a pumping loop comprised of ¼″ stainless steel tubing, a small impeller pump (Bayite BYT-7A014 DC 12V Solar Hot Water Heater Circulation Pump Low Noise 3M Discharge Head 2.1GPM), a flow valve, and a shunt valve allowing return flow to the 4 L hopper. The system allows the pump to be operated at constant voltage, yet the pumping rate into the reactor to be variable. Influent enters the bottom of the reactor and flows upward to fill it. Solution flows from the reactor through ¼″ stainless steel tube attached 5 cm from the top of the reactor. The solution flows from the reactor under pressure which is adjusted by a valve. The solution flows through this valve and into a collection beaker. Reactor effluent is collected from the flow into this beaker.

At the beginning of each experiment, the 4 L hopper is fully emptied from and the reactor is drained. A fresh PFAS containing solution is poured into the 4 L hopper, the lamp turned on, and the solution flowed into the reactor system at ~50 ml/minute. At the first drip of effluent into the collection beaker, a timer is started. Effluent was sampled at ~150 ml intervals. Samples are tested for free-fluoride and parent compound (PFBA) destruction.

All solutions studied comprise a solution of 23.4 micromolar (5 ppm by weight) perfluorobutanoic acid (PFBA, research grade, Sigma Aldrich) at pH 12 (20 millimolar NaOH, Sigma Aldrich). Sodium Sulfite (reagent grade, Cessec, USA) and Potassium iodide (reagent grade, Deepwater Chemicals, Inc) and sodium sulfate (reagent grade, Sigma Aldrich) were added in amounts indicated. All solutions were mixed immediately prior to beginning the experiment. The solution flowed through the reactor at 50 mL/minute in all experiments.

To establish that there is sufficient ionic conductivity between the anode and cathode in the reactor, 0.5 M sulfate and 2 mM iodide was first tested without any sulfite or PFBA. The UV light source was turned off during this portion of the experiment. The results are shown in Table 13, Samples 1a-1c. At a threshold of 1.9 V, the effluent solution was observed to be visibly brown, implying the probable presence of an oxidized species of iodide and confirming adequate ionic conductivity through the solution to establish an electrolytic circuit. A solution of 5 ppm PFBA was then mixed with 5 mM sulfite, 2 mM iodide, and 0.5 M sulfate. A control sample (1d) of this solution was taken before any bias was applied between the electrodes and the 254 nm lamp turned off. The sample was then flowed through the reactor at 50 ml/min with a bias of 2 Volts applied between the anode and the cathode with the lamp turned on. After one reactor volume had passed, two samples were taken at ~150 ml intervals. The results are shown in Table 13, Samples 1e-1g. The average destruction was 64.1% and average defluorination 28.8%. The same study was repeated with the lamp on with no bias applied between the anode and cathode. The average destruction was 30.0% and average defluorination 8.7%. These results are reported in Table 13 (rows 1 h and 1i). This experiment demonstrates that a cathode and anode can be placed within the same reaction chamber in a continuous flow reactor that is destroying PFAS, and that a newly formed chemical, most likely an oxidized form of iodide such as iodide, triiodide, or a mixture of polyiodides (see Example 16), is present in the effluent when a bias exceeding a threshold value of about 2 V is applied between the anode and cathode. Additionally, the experiment demonstrates enhanced PFAS degradation when a bias of exceeding a threshold of about 2V is applied between the anode and the cathode.

TABLE 13
Results showing what happens when a cathode and anode are placed with
in the reaction chamber of a continuous flow reactor destroying PFAS

| | | | | | | | | Free | |
|---|---|---|---|---|---|---|---|---|---|
| | | Current | PFBA | KI | Sulfite | Sulfate | Destruction | Fluoride | |
| Sample | Voltage | (Amps) | (ppm) | (mM) | (mM) | (mM) | (%) | (%) | Comments |
| 1a | 1.2 | 0.09 | 0 | 2 | 0 | 500 | — | — | Clear Effluent |
| 1b | 2.2 | 0.18 | 0 | 2 | 0 | 500 | — | — | Brown Effluent |
| 1c | 2.9 | 0.60 | 0 | 2 | 0 | 500 | — | — | Brown Effluent |
| 1d | 0 | — | 5 | 2 | 5 | 500 | 0.0 | 0 | Influent, 1.089 ppm free fluorine zero-point |
| | | | | | | | | | baseline from sulfate interference. |
| 1e | 2.0 | 0.10 | 5 | 2 | 5 | 500 | 58.4 | 25.3 | Brown Effluent |
| 1f | 2.0 | 0.08 | 5 | 2 | 5 | 500 | 64.9 | 28.6 | Brown Effluent |
| 1g | 2.0 | 0.08 | 5 | 2 | 5 | 500 | 69.1 | 32.6 | Brown Effluent |
| 1h | 0 | — | 5 | 2 | 5 | 500 | 33.9 | 9.6 | Clear Effluent |
| 1i | 0 | — | 5 | 2 | 5 | 500 | 26.1 | 7.8 | Clear Effluent |

### Example 16

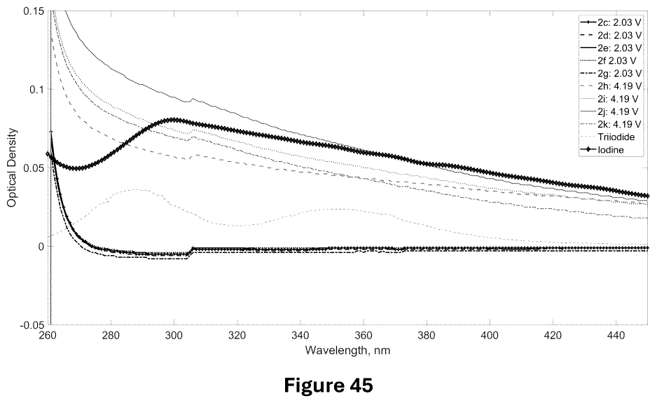

This example tests the effect of PFAS destruction in the same continuous reactor presented in Example 15 but without the addition of sulfate as a supplemental electrolyte. The results of this experiment are presented in Table 14. A solution of 5 ppm PFBA was mixed with 10 mM sulfite and 2 mM iodide, and the solution flowed through the reactor at 50 ml/min with a bias of 2 Volts applied between the anode and the cathode. After one reactor volume had passed, two samples were taken at periodic intervals. The effluent solution did not appear visibly colored, in contrast to the experiments presented in Example 15 in which 0.5 M sulfate was included in the solution. The results are shown in Table 14, Samples 2a-2g. The average destruction was 93.5% and average de-fluorination 35.5%. After 2200 ml of effluent had passed, the applied bias was increased to 4.17 Volts. The average destruction was 93.8% and average de-fluorination 36.6%. At this voltage, the effluent was visibly brown (Table 14, Samples 2 h-2k). The UV-Vis spectrum of the effluent samples presented in this example were recorded. The absorbance as a function of wavelength is plotted in FIG. 45. A broad feature in the visible part of the spectrum whose optical absorbance increases with increasing photon energy clearly appears in samples that experience 4.17 applied voltage. This feature is clearly not present with 2.03 Volts applied.

The measured absorption spectrum in the visible region of the spectrum is characteristically similar to a published spectra molecular iodine [Kireev, S. V et. al Laser Phys. 25 (2015) 075602], particularly at longer wavelengths. The published spectra is plotted on FIG. 45 along with the experimental data. Based on the known extinction coefficient of molecular iodide at 415 nm which is 502 L/mol/cm, it is reasonable to assert that 5-10% of the original 2 mM iodide has been oxidized to molecular iodine and/or triiodide. A non-scaled triiodide spectrum obtained from scientific literature is plotted on FIG. 45 for reference [Kireev, S. V et. al Laser Phys. 25 (2015) 075602].

This experiment demonstrates that a cathode and anode can be placed within the same reaction chamber in a continuous flow reactor that is destroying PFAS and that a newly formed chemical, most likely triiodide or iodine (see Example 15), is present in the effluent when a voltage exceeds a threshold required to produce and appreciable electrochemical current. When compared with the results from Example 15, these results also show that the threshold current required to initiate iodide oxidation depends on the chemical composition of the solution, and decreases for solutions containing higher ionic strength, as expected based on established principles of ion transport. Furthermore, Examples 15 and 16 together show that iodide oxidation may occur with or without enhanced PFAS destruction.

TABLE 14

| | | | | | Free | |
|---|---|---|---|---|---|---|
| | Effluent | | | Destruction | Fluoride | |
| Sample | (ml) | Voltage | Amps | (%) | (%) | Comments |
| 2a | 0 | 2.03 | 0.113 | 0.0 | 0.0 | No vis abs |
| 2b | 750 | 2.03 | 0.113 | 93.1 | 29.8 | No vis abs |
| 2c | 850 | 2.03 | 0.113 | 92.2 | 32.3 | No vis abs |
| 2d | 1300 | 2.03 | 0.113 | 91.9 | 33.4 | No vis abs |
| 2e | 1750 | 2.03 | 0.113 | 94.8 | 39.8 | No vis abs |
| 2f | 1950 | 2.03 | 0.113 | 95.4 | 37.6 | No vis abs |
| 2g | 2150 | 2.03 | 0.113 | 93.9 | 38.0 | No vis abs |
| 2h | 2300 | 4.17 | 1.85 | 95.8 | 39.6 | Vis Abs |
| 2i | 2350 | 4.17 | 1.85 | 94.6 | 37.5 | Vis Abs |
| 2j | 2400 | 4.17 | 1.85 | 92.3 | 35.9 | Vis Abs |
| 2k | 2500 | 4.17 | 1.85 | 92.5 | 33.5 | Vis Abs |

1. A method of destroying PFAS using an advanced reductive process comprising:
exposing a PFAS solution to ultraviolet light from an ultraviolet light source, the ultraviolet light source comprising one or more bulbs having a maximum light intensity at 200 nm to 250 nm,
wherein the PFAS solution comprises:
one or more PFAS, the PFAS having an initial concentration of carbon fluorine bonds; and
a photosensitizer comprising a sulfite salt, the sulfite salt having a concentration of a minimum of 0.1 mM to a maximum of 10 times the concentration of carbon fluorine bonds of the PFAS; and
wherein the PFAS solution has a pH of 9 or higher.

2. The method of claim 1 further comprising removing oxygen from the PFAS solution using the sulfite salt, wherein the sulfite salt has a minimum initial concentration of 0.3 mM in the PFAS solution before removing oxygen.

3. The method of claim 1, wherein the sulfite salt is not used to remove oxygen from the incoming solution.

4. The method of claim 1 wherein the photosensitizer further comprises a halide salt.

5. The method of claim 4 wherein the halide salt comprises a bromide salt or an iodide salt.

6. The method of claim 5 wherein the halide salt comprises a bromide salt and wherein the bromide salt has a concentration of 1 mM to 40 mM in the PFAS solution.

7. The method of claim 5 wherein a ratio of the bromide salt concentration to the sulfite salt concentration in the PFAS solution is 0.1 to 100.

8. The method of claim 5 wherein a ratio of the bromide salt concentration to the sulfite salt concentration in the PFAS solution is 1 to 80.

9. The method of claim 5 wherein the halide salt comprises an iodide salt and wherein the iodide salt has a concentration of 1 micromolar to 100 micromolar in the PFAS solution.

10. The method of claim 5 wherein a ratio of the iodide salt concentration to the sulfite salt concentration in the PFAS solution is 0.001 to 1.

11. The method of claim 5 wherein a ratio of the iodide salt concentration to the sulfite salt concentration in the PFAS solution is 0.0016 to 0.2.

12. The method of claim 1, wherein the sulfite salt is the only photosensitizer in the PFAS solution.

13. The method of claim 1, wherein the PFAS solution does not include a halide salt.

14. The method of claim 1 wherein the ultraviolet light source maximum light intensity is 200 nm to 230 nm.

15. The method of claim 1, wherein the ultraviolet light source comprises an excimer lamp.

16. The method of claim 14, wherein the excimer lamp comprises a krypton/chloride lamp.

17. The method of claim 14 wherein the excimer lamp has a maximum light intensity at about 222 nm.

18. A method of destroying PFAS comprising:
continuously flowing an aqueous solution through one or more photochemical reactors, the aqueous solution comprising:
one or more PFAS, the PFAS having an initial concentration of carbon fluorine bonds; and
a photosensitizer comprising a sulfite salt at a concentration between a minimum of 0.1 mM and a maximum of no greater than 10 times the concentration of carbon fluorine bonds; and
a pH of 9 or higher; and
exposing the continuously flowing aqueous solution to UV light from one or more UV light sources in the one or more photochemical reactors, the UV light sources producing UV light with a maximum light intensity at 200 nm to 250 nm.

19. The method of claim 18, the photosensitizer further comprising a halide salt.

20. The method of claim 19 wherein the halide salt comprises a bromide salt or an iodide salt.

21. The method of claim 19 wherein the halide salt comprises a bromide salt and wherein the bromide salt has a concentration of 1 mM to 40 mM in the aqueous solution.

22. The method of claim 19 wherein a ratio of the bromide salt concentration to the sulfite salt concentration in the PFAS solution is 0.1 to 100.

23. The method of claim 19 wherein a ratio of the bromide salt concentration to the sulfite salt concentration in the PFAS solution is 1 to 80.

24. The method of claim 19 wherein the halide salt comprises an iodide salt and wherein the iodide salt has a concentration between 1 micromolar to 100 micromolar in the aqueous solution.

25. The method of claim 19 wherein a ratio of the iodide salt concentration to the sulfite salt concentration is 0.001 to 1.

26. The method of claim 19 wherein a ratio of the iodide salt concentration to the sulfite salt concentration is 0.0016 to 0.2.

27. The method of claim 18, wherein the sulfite salt is the only photosensitizer in the PFAS solution.

28. The method of claim 18, wherein the PFAS solution does not include a halide salt.

29. The method of claim 18 wherein the one or more photochemical reactors comprises two or more photochemical reactors in series, with the aqueous solution flowing continuously through the two or more photochemical reactors.

30. A continuous flow UV photoreactor comprising:
a reactor vessel comprising:
a tube comprising a proximal end, an opposing distal end, a proximal portion and a distal portion, wherein the proximal portion is relatively closer to the proximal end and the distal portion is relatively closer to the distal end;
a fluid inlet at the proximal end;
a fluid outlet at the distal end;
a photochemical chamber within the tube between the proximal and distal ends;
one or more elongated UV lamps in the photochemical chamber;
one or more cathodes within the photochemical chamber; and
one or more anodes distal to the one or more cathodes, wherein the one or more anodes are electrically connected to the one or more cathodes.
